(19) United States
(12) Patent Application Publication
(10) Pub. No.: US 2025/0181961 A1
(43) Pub. Date: Jun. 5, 2025

(54) APPARATUS AND METHOD FOR DETERMINING AN IMPACT OF HIGH-BEAM LIGHTS ON BEHAVIORS OF USERS

(71) Applicant: HERE GLOBAL B.V., EINDHOVEN (NL)

(72) Inventor: JEROME BEAUREPAIRE, COURBEVOIE (FR)

(73) Assignee: HERE GLOBAL B.V., EINDHOVEN (NL)

(21) Appl. No.: 18/523,946

(22) Filed: Nov. 30, 2023

(51) Int. Cl. G06N 20/00; G01C 21/34; G06N 7/01

(52) U.S. Cl. CPC G06N 20/00; G01C 21/3461; G06N 7/01

(57) ABSTRACT

An apparatus and a method for determining an impact of high-beam lights on behaviors of vehicle users are disclosed. The apparatus obtains sensor data and map data associated with at a first vehicle, wherein the obtained map data is obtained from a map database. The apparatus further calculates a first probability score indicative of a usage of high-beam lights by the first vehicle based on the obtained sensor data and the obtained map data. Responsive to the calculated first probability score satisfying a threshold, the apparatus calculates a second probability score indicative of an impact on a behavior of a user of a second vehicle within a pre-determined distance of the first vehicle based on the obtained sensor data and the obtained map data. Further, the apparatus stores, in the map database, association data indicative of an association between the obtained map data and the calculated second probability score.

### TECHNOLOGICAL FIELD

The present disclosure generally relates to assessing behaviors of drivers of vehicles, and more particularly relates to an apparatus and a method for determining an impact of high-beam lights on behaviors of users.

### BACKGROUND

With advancements in the field of automotive engineering and with a decrease in the cost of acquisition of vehicles, there is a continuous rise in a number of vehicles plying on roads nowadays. While driving on the roads, multiple safety guidelines need to be followed by drivers of the vehicles for their safety and the safety of other drivers whose vehicles are plying on the road. Such safety guidelines include, but are not limited to, exercising caution and discretion in a usage of high-beam lights.

High-beam lights are the brightest type of lights installed on vehicles. High-beam lights are angled higher than dipped lights (or low-beam lights), that are used to maximize visibility during periods of low light, such as on dark highways or remote roads with no oncoming traffic. They emit a brighter and broader light pattern but should be used judiciously to avoid blinding other drivers. There may exist certain situations, such as poor visibility due to rain, fog, etc., during driving that make it necessary to use the high-beam lights. However, the usage of high-beam lights may lead to various issues while driving. Some of these issues include reduced visibility, disorientation, distraction, and eye strain. In particular, high-beam lights may be extremely bright and may therefore cause glare thereby reducing the visibility of other drivers on the road. Reduced visibility may be dangerous while driving at night or in foggy conditions. Further, high-beam lights may be disorienting for other drivers, causing the other drivers to lose their bearings or become distracted. Such disorientation may lead to accidents or other dangerous situations on the road. Furthermore, high-beam lights may distract other drivers, causing them to look away from the road or to become momentarily blinded. This distraction may increase the risk of a crash or other accidents. Moreover, the usage of high-beam lights may cause eye strain and fatigue, especially when driving for long periods of time, which may reduce the driver's ability to see clearly and make good decisions on the road. Therefore, it is important to use high-beam lights only when necessary, such as when driving on a deserted road or in conditions with low visibility. However, a driver may not always be able to exercise the best judgment for deciding whether to use high-beam lights or not. This may put the driver and/or the other drivers on the road in a dangerous situation.

Thus, there is a need to overcome the challenges described above and provide safe vehicular navigation services for users of vehicles.

### BRIEF SUMMARY OF SOME EXAMPLE EMBODIMENTS

An apparatus, a method, and a computer programmable product are provided for implementing the process for determination of the impact of high-beam lights on the behavior of users.

In one aspect, an apparatus for the determination of the impact of high-beam lights on the behavior of users is disclosed. The apparatus includes at least one processor and at least one non-transitory memory including computer program code instructions. The computer program code instructions are further configured to, when executed, cause the apparatus to obtain sensor data and map data associated with a first vehicle. The obtained map data may be obtained from a map database. The computer program code instructions are further configured to when executed, cause the apparatus to calculate a first probability score indicative of a usage of high-beam lights by the first vehicle based on the obtained sensor data and the obtained map data. The computer program code instructions are further configured to, when executed, cause the apparatus to calculate a second probability score indicative of an impact on a behavior of a user of a second vehicle within a pre-determined distance of the first vehicle based on the obtained sensor data and the obtained map data. The second probability score may be calculated in response to the calculated first probability score satisfying a threshold. The computer program code instructions are further configured to, when executed, cause the apparatus to store, in the map database, association data indicative of an association between the obtained map data and the calculated second probability score.

In additional apparatus embodiments, the obtained sensor data includes vehicle data, weather data, environmental data, temporal data, or a combination thereof. The obtained map data includes traffic data, link data, or a combination thereof.

In additional apparatus embodiments, to calculate the first probability score, the computer program code instructions are configured to, when executed, cause the apparatus to apply a first machine learning (ML) model on the obtained sensor data and the obtained map data, and calculate the first probability score indicative of the usage of the high-beam lights by the first vehicle based on the application of the first ML model on the obtained sensor data and the obtained map data.

In additional apparatus embodiments, to calculate the second probability score, the computer program code instructions are configured to, when executed, cause the apparatus to apply a second ML model on the obtained sensor data and the obtained map data, and calculate the second probability score based on the application of the second ML model on the obtained sensor data and the obtained map data.

In additional apparatus embodiments, the computer program code instructions are configured to, when executed, further cause the apparatus to obtain training data. The obtained training data corresponds to the obtained sensor data and the obtained map data and indicates features of one or more events in which the high-beam lights of a set of vehicles were used and the usage of the high-beam lights impacted other vehicles. The computer program code instructions are configured to, when executed, cause the apparatus to train a first machine learning (ML) model and a second ML model based on the training data. Therefore, to calculate the first probability score, the computer program code instructions are configured to, when executed, cause the apparatus to apply the trained first ML model on the obtained sensor data and the obtained map data, and calculate the first probability score indicative of the usage of the high-beam lights by the first vehicle based on the application of the trained first ML model on the obtained sensor data and the obtained map data. Similarly, to calculate the second probability score, the computer program code instructions are configured to, when executed, cause the apparatus to apply the trained second ML model on the obtained sensor data and the obtained map data, and calculate the second probability score based on the application of the trained second ML model on the obtained sensor data and the obtained map data.

In some embodiments, the training data may include training sensor data acquired by the set of vehicles during the one or more events and training map data indicating features of the one or more events. The training sensor data and the obtained sensor data are different. Further, training map data and the obtained map data are different.

In additional apparatus embodiments, the one or more events may be defined, at least in part, by instances in which vehicle speeds of the other vehicles changed during the one or more events; trajectories of the other vehicles changed during the one or more events; lights of the other vehicles flashed during the one or more events; mirrors of the other vehicles were adjusted during the one or more events; gazes of drivers of the other vehicles changed during the one or more events; orientations of the drivers of the other vehicles changed during the one or more events; facial expressions of the drivers of the other vehicles changed during the one or more events; or a combination thereof.

In additional apparatus embodiments, the computer program code instructions are configured to, when executed, cause the apparatus to render, based on the stored association data, an alert on a user interface.

In additional apparatus embodiments, the computer program code instructions are configured to, when executed, cause the apparatus to receive a user input associated with a determination of a navigation route from an origin location to a destination location. The computer program code instructions are configured to, when executed, cause the apparatus to determine, from the map database, a first navigation route from the origin location to the destination location based on the stored association data, and output the first navigation route on a user interface.

In another aspect, a method of determination of impact of high-beam lights on behavior of users of vehicles is disclosed. The method includes obtaining sensor data and map data associated with a first vehicle. The obtained map data may be obtained from a map database. The method further includes calculating a first probability score indicative of a usage of high-beam lights by the first vehicle based on the obtained sensor data and the obtained map data, and in response to the calculated first probability score satisfying a threshold, calculating a second probability score indicative of an impact on a behavior of a user of a second vehicle within a pre-determined distance of the first vehicle based on the obtained sensor data and the obtained map data. The method further includes storing, in the map database, association data indicative of an association between the obtained map data and the calculated second probability score.

In additional methods, the obtained sensor data may include vehicle data, weather data, environmental data, temporal data, or a combination thereof. The obtained map data includes traffic data, link data, or a combination thereof.

In additional methods, the method includes applying a first machine learning (ML) model on the obtained sensor data and the obtained map data and calculating the first probability score indicative of the usage of the high-beam lights by the first vehicle based on the application of the first ML model on the obtained sensor data and the obtained map data.

Further, the method includes applying a second ML model on the obtained sensor data and the obtained map data and calculating the second probability score based on the application of the second ML model on the obtained sensor data and the obtained map data.

In additional methods, the method includes obtaining training data. The obtained training data may correspond to the obtained sensor data and the obtained map data and indicate features of one or more events in which the high-beam lights of a set of vehicles were used and the usage of the high-beam lights impacted other vehicles. The method further includes training a first machine learning (ML) model and a second ML model based on the training data. The calculating the first probability score includes applying the trained first ML model on the obtained sensor data and the obtained map data and calculating the first probability score indicative of the usage of the high-beam lights by the first vehicle based on the application of the trained first ML model on the obtained sensor data and the obtained map data. Similarly, the calculating the second probability score includes applying the trained second ML model on the obtained sensor data and the obtained map data and calculating the second probability score based on the application of the trained second ML model on the obtained sensor data and the obtained map data.

In additional methods, the training data includes training sensor data acquired by the set of vehicles during the one or more events and training map data indicating features of the one or more events. The training sensor data and the obtained sensor data are different. The training map data and the obtained map data are different. The one or more events may be defined, at least in part, by instances in which vehicle speeds of the other vehicles changed during the one or more events; trajectories of the other vehicles changed during the one or more events; lights of the other vehicles flashed during the one or more events; mirrors of the other vehicles were adjusted during the one or more events; gazes of drivers of the other vehicles changed during the one or more events; orientations of the drivers of the other vehicles changed during the one or more events; facial expressions of the drivers of the other vehicles changed during the one or more events; or a combination thereof.

In additional methods, the method includes rendering, based on the stored association data, an alert on a user interface. The method further includes receiving a user input associated with a determination of a navigation route from an origin location to a destination location. The method includes further determining, from the map database, a first navigation route from the origin location to the destination location based on the stored association data and outputting the first navigation route on a user interface.

In yet another aspect, a non-transitory computer readable medium having stored thereon computer executable instructions is described. The computer program code instructions, when executed by at least one processor, cause the at least one processor to carry out operations for determining the impact of high-beam lights on behavior of users of vehicles. The computer program code instructions, when executed by the at least one processor, cause the at least one processor to obtain sensor data and map data associated with a first vehicle. The obtained map data may be obtained from a map database. The computer program code instructions, when executed by the at least one processor, cause the at least one processor to calculate a first probability score indicative of a usage of high-beam lights by the first vehicle based on the obtained sensor data and the obtained map data. The computer program code instructions, when executed by the at least one processor, cause the at least one processor to, in response to the calculated first probability score satisfying a threshold, calculate a second probability score indicative of an impact on a behavior of a user of a second vehicle within a pre-determined distance of the first vehicle based on the obtained sensor data and the obtained map data. The computer program code instructions, when executed by the at least one processor, cause the at least one processor to store, in the map database, association data indicative of an association between the obtained map data and the calculated second probability score.

In additional non-transitory computer readable medium embodiments, the obtained sensor data includes vehicle data, weather data, environmental data, temporal data, or a combination thereof, and the obtained map data comprises traffic data, link data, or a combination thereof.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, references will now be made to the accompanying drawings, which are not necessarily drawn to scale, and wherein:

FIG. 1 is a diagram that illustrates a network environment for determining an impact of high-beam lights on behavior of users of vehicles, in accordance with an embodiment of the disclosure;

FIG. 2 illustrates a block diagram of the apparatus of FIG. 1, in accordance with an embodiment of the disclosure;

FIG. 3 is a diagram that illustrates exemplary operations for determining an impact of high-beam lights on behavior of users of vehicles, in accordance with an embodiment of the disclosure;

FIG. 4A is a diagram that depicts an exemplary scenario including a first vehicle and a second vehicle, with the first vehicle having its low-beam lights switched ON, in accordance with an embodiment of the disclosure;

FIG. 4B is a diagram that depicts an exemplary scenario including the first vehicle and the second vehicle, with the first vehicle having its high-beam lights switched ON, in accordance with an embodiment of the disclosure;

FIG. 5A and FIG. 5B collectively illustrate exemplary scenarios of additional functionalities including alert generation by the apparatus, in accordance with some embodiments of the disclosure;

FIG. 6A is a diagram that illustrates a process of training a first ML model of a set of ML models for calculating a first probability score, in accordance with an embodiment of the disclosure;

FIG. 6B is a diagram that illustrates a process of training a second ML model of the set of ML models for calculating a second probability score, in accordance with an embodiment of the disclosure;

FIG. 7 is a flowchart that illustrates an exemplary method for determining an impact of high-beam lights on behavior of users of vehicles, in accordance with an embodiment of the disclosure;

FIG. 8 is a flowchart that illustrates an exemplary method of calculating a first probability score, in accordance with an embodiment of the disclosure;

FIG. 9 is a flowchart that illustrates an exemplary method of calculating a second probability score, in accordance with an embodiment of the disclosure; and

FIG. 10 is a flowchart that illustrates an exemplary method of determining a first navigation route on a user interface, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

The present disclosure relates to an apparatus, a method, and a computer programmable product for determining a likelihood of a vehicle using high-beam lights and a likelihood of an impact of the high-beam lights on behaviors of users of other vehicles.

As mentioned above, high-beam lights may be used in adverse weather conditions like fog, rain, etc., or while driving in areas with unlit roads where there is oncoming traffic or pedestrians. In other scenarios, it may be preferable to use low-beam lights. For example, low-beam lights may be preferred when driving behind other vehicles, since the high-beam lights may cause glare and make it difficult for the driver of the other vehicle to clearly see the road and the traffic plying on the road. Therefore, it becomes important to switch between high-beam lights and low-beam lights. It is generally recommended to switch from low-beam to high-beam lights when driving on a highway or other open roads where there are no other vehicles around. This is because high-beam lights provide a longer and brighter view of the road and traffic, which may help a driver see further ahead and more clearly. As such, it is important to remember to switch back to low-beam lights when there is oncoming traffic or when following another vehicle closely, as high-beam lights may be blinding to other drivers.

The decision to switch between the high-beam and low-beam lights may depend on various parameters, including map-related parameters (i.e. slope, geometry, curvature, etc.) as well as the predicted route when no destination is set (called “electronic horizon” or most probable path). However, additional contextual information may prove beneficial, which the present disclosure aims to implement.

Therefore, there is a need for a method for having insights on detecting locations, links, or contexts where vehicle lights are configured in the high beam, so that such insights may be leveraged to increase the safety and comfort of the drivers. Further, there is a need to detect the impact of high-beam lights on other drivers to determine when the high-beam lights are disturbing or even dangerous for other drivers. In other words, there is a need for predicting when and where high-beam lights may be used and what may be the impact of the usage of the high-beam lights on other drivers, thereby making usage of the high-beam lights efficient and safe.

The present disclosure provides for implementing a set of Machine Leaning (ML) models that are configured to predict the likelihood of people using high-beam lights on any given link at any given time, as well as predict the likely impact on other drivers of the usage of the high-beam lights. To train the set of ML models, it may be important to detect events in which high-beam lights were used and acquire training data indicating features of said events. The detection of when and where the high-beam lights were used may be rendered by one or more sensors within a vehicle (e.g., sensors for detecting luminosity of vehicle head lights), by remotely leveraging sensors (camera sensors, Radio Detection And Ranging (RADAR) sensors, Light Detection and Ranging (LIDAR) sensors) of other vehicles, or by using traffic safety sensors (e.g. traffic camera sensors). It may also be important to detect whether the high-beam lights were triggered manually by the driver or automatically by the vehicle's electronic control unit (ECU). This information may be captured directly by the apparatus and may help to understand and learn whether the high-beam lights are triggered more by humans or automatically (by the car system).

Another objective of the present subject matter is to provide an apparatus that may detect when and where the use of high-beam lights causes a change in the behaviors of drivers of other vehicles. As mentioned above, a driver using high-beam lights of a vehicle may have an impact on neighboring drivers, particularly drivers that are driving ahead of the driver, drivers that are driving towards the front side of the vehicle, or drivers that at the intersection as the vehicle. To detect the impact of the use of high-beam lights on the other drivers, the apparatus described in the present disclosure may leverage the sensors, such as built-in sensors within vehicles of the drivers or roadside sensors proximate to the vehicles, to detect changes in driving patterns. For example, the driving patterns may include slowing down of vehicles, and changing trajectories (e.g., changing lanes, maneuvering to different positions within a lane, maneuvering the vehicles over edges of the lane markings, etc.). The apparatus may further analyze the drivers' possible feedback, such as drivers flashing vehicle head lights to express discomfort. Further, the apparatus may analyze changes made to positions of rear view mirrors in the vehicles for determining impact of high-beam lights. Moreover, the apparatus may analyze whether drivers are looking away towards a side of a road, for example, using system indoor cameras of the vehicles, which are generally used to measure driver fatigue or detect emotions. In particular, the apparatus may consider events, such as instances where high-beam lights are used by vehicles and instances where the high-beam lights caused changes in driving behaviors of drivers of other vehicles. To this end, the apparatus may consider various factors, for each of the events, including the time of the event, the start of the event, duration of the event, end of the event, number of vehicles impacted by the event, speed of the vehicle, weather conditions, visibility, traffic conditions, functional class of a road, etc.

The events described above may be tracked during operation so that the apparatus may be able to learn from the patterns associated with the events. As such, upon detecting the events (for example, using various sensors, as explained above) where high-beam lights are used and where high-beam lights cause a change in behaviors of drivers of other vehicles, the events are marked on a map, together with their characteristics. The events may be mapped at a link level, considering the offset on the links. Alternately, the events may be aggregated on a different spatial entity.

The above mapping of the events is then translated into a vector format suitable to be used as a feature vector for Machine Learning (ML) models. The ML models are trained or pre-trained to generate an output based on the detection of events in real-time. The ML models may perform a standard regression or classification task. In particular, a first ML model may be used to predict whether a driver will use high-beam lights or not on a given link at a given time. To this end, the following features may be taken into consideration traffic conditions, time of the day, i.e. day or night, functional classes of roads (i.e. highway, city center, rural roads, etc.), road width, presence of physical divider, extreme weather conditions (heavy rain, fog, etc.), vehicle speed, heading degree difference (e.g. vehicle heading degree, link heading degree), road curvature, road ascent/descent degree, road works, presence of tree or infrastructure on the edge of the road (e.g. in terms of “Yes” or “No”), type of vehicle (i.e. small car, sedan, small truck, truck, utility, etc.), and type of transmission (e.g. automatic or manual). In short, features related to sensor data (i.e. vehicle data, weather data, environmental data, temporal data, or a combination thereof) and features related to map data (i.e. traffic data, link data, or a combination thereof) are considered. As such, while training and using the ML models, a label is applied. For example, the label may correspond to whether the high-beam lights have been used or not. Further, historical data collected for the features and the corresponding labels may be considered as well.

Based on the above data, the first ML model may be trained. When a vehicle starts moving, current features are extracted, for example, from preinstalled map applications and sensors. These features are then fed into the trained first ML model. The first ML model predicts whether the driver will use high-beam lights on a link or not, and correspondingly a probability score is calculated. The probability score may vary from 0 to 1. With the inputs described above, the apparatus may be able to learn when and where the drivers will be using high-beam lights.

A second ML model may predict whether the high-beam lights will cause changes in the driving behaviors of drivers of other vehicles. If the output of the first ML model is above a threshold value (for example, 0.7), then the same features are passed on to the second ML model. For the second ML model, the features may remain the same, however, the label(s) may change. In particular, the label may have two outputs—“Yes” and “No”. Here, “Yes” may indicate a high probability of the driver adapting her/his behavior, and “No” may indicate a low probability of the driver adapting her/his behavior. The output of the second ML model may also be a probability score ranging from 0 to 1. If the output of the second ML model is greater than the threshold value (e.g. 0.7), then there may be a high probability of the driver adapting her/his behavior in response to facing high-beam lights.

In some embodiments, the transfer learning may be applied to the first and the second ML models. As will be appreciated by those skilled in the art, transfer learning may be applied in scenarios where historical information may not be available. As such, the ML models (i.e. the first ML model and the second ML model) are used as a baseline, until data is collected in such areas and the models may then be adapted to better match local behaviors.

The ML models may make use of mobility graphs (i.e. historical mobility patterns). In other words, the ML models may leverage historical information from a given user or set of users (e.g. drivers) who may tend to accomplish the same actions (i.e. turning ON or OFF high-beam lights) at the same locations due to habits. The ML models may also capture contexts leading to the frequent switches of low/high-beam lights. The information about repeated patterns may be used to learn and make more accurate predictions.

The above techniques of the present disclosure provide various advantages, in terms of the safety of vehicles, avoiding sudden (surprising) glare for other drivers, user experience, and comfort of driving. For example, the above techniques help in reducing the number of unnecessary switches. Further, the techniques help in detecting when vehicles are triggering too many unnecessary switches between low-beam and high-beam lights, based on the output of the ML models. For example, the techniques help in detecting whether switches happen within a certain time period, for example, less than 5 seconds. Further, the techniques enable learning all the locations and contexts in which such frequent switches occur and whether they are manually or automatically triggered by the vehicle. For example, when there are lots of unnecessary switches at night (e.g. between 7 PM and 8 PM on a weekday) on a given link, the techniques assist in deciding whether to change its criteria before switching to high-beam or be more conservative before doing so. In some extreme cases, the techniques may decide to not even use high-beam lights on a link, as that may create more confusion and discomfort for all the drivers than adding real value. The analysis performed by the apparatus of the present disclosure may be applied to different transport modes including cars, trucks, motorbikes and bikes, micro-mobility vehicles, etc.

The apparatus may provide for some additional functionalities, apart from the above functionalities of identifying the contexts (locations/areas, time, weather, etc.) leading to unsafe or improper use of high-beam lights and determining the impact of using the high-beam lights. These additional functionalities may include rendering on a map the areas which have a high number of vehicles that are using or are likely to use high-beam lights (for example, at some time of the day or under the current context of traffic and weather conditions). The functionalities may further include assisting in routing. To this end, user inputs may be considered for the routing, because drivers who have eye-related issues or are sensitive to lights may prefer a route with a limited risk of drivers using their lights improperly.

The functionalities may include guiding the drivers as to the use of high beam lights. For example, audio guidance outputs like: “Pay attention. This area is known to have some people using high-beam lights improperly in a similar context in the past. So beware of this area” may be generated for guiding through individual areas. Moreover, visual guidance may be provided by visually highlighting the possibility of coming across vehicles with high-beam lights when driving on a particular road segment.

The functionalities further may include providing warnings as to certain locations. People may be warned to pay special attention at some given locations and times, for example, just after a curve or intersection. The functionalities may include creating reminders or contextual recommendations as to how to reduce or be less impacted by high-beam lights (if that happens). For example, while driving on a road with multiple lanes, the driver may be reminded to stay in the ‘right lane’ to avoid head-on glare from oncoming vehicles. In another example, the driver may be reminded to use the vehicle's visor to shield their eyes from the glare of oncoming lights. Moreover, a recommendation may be generated for the driver to consider a pair of glasses with an anti-reflective coating to reduce glare. Another recommendation may include a visual or audio message, such as “Keep your windshield clean to reduce glare from lights”. Furthermore, during driving at night with the road ahead being poorly lit, a recommendation may be generated about slowing down to give more time to react to any hazards that may be on the road. The above functionalities may be used with Autonomous vehicles (AVs) that may be able to understand where and when the AVs may be more likely to see other vehicles with high-beam lights, as this might impact the comfort of their passengers. Further, the functionalities may extend to Advanced Driver Assistance Systems (ADAS) to make plying on the roads safer.

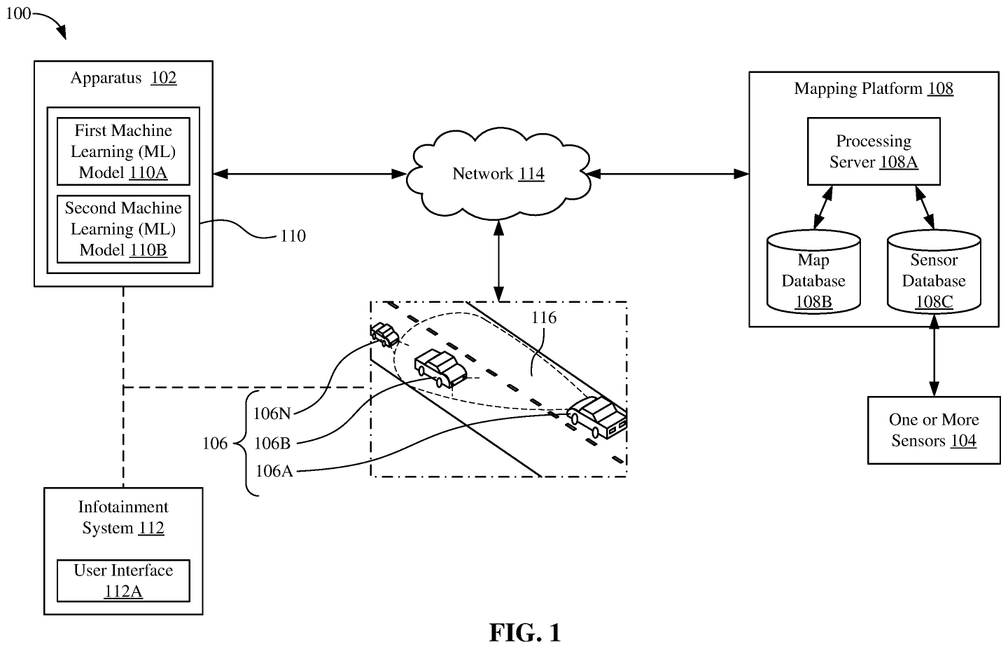

FIG. 1 is a diagram that illustrates a network environment 100 for determining an impact of high-beam lights on behavior of users of vehicles, in accordance with an embodiment of the disclosure. With reference to FIG. 1, there is shown a diagram of the network environment 100. The network environment 100 includes an apparatus 102, a set of vehicles 106, and a mapping platform 108. The network environment 100 may further include one or more sensors 104. In one embodiment, the one or more sensors vehicle 104 may include sensors that may be present inside a vehicle. In one embodiment, the one or more sensors 104 may further include stationary traffic cameras installed within or adjacent to roadways and sensors of other vehicles (e.g., cameras, RADAR sensors, LIDAR sensors, etc.).

The apparatus 102 may include a set of machine learning (ML) models 110. The set of ML models 110 may include a first ML model 110A and a second ML model 110B. The set of vehicles 106 may include a first vehicle 106A, a second vehicle 106B, and up to an Nth vehicle 106N. In some example implementations, each of the set of vehicles 106 may include the one or more sensors 104. The mapping platform 108 may include a processing server 108A, a map database 108B, and a sensor database 108C. The network environment 100 may further include an infotainment system 112, and a network 114. The infotainment system 112 may include a user interface (UI) 112A. The set of vehicles 106 may be traveling on a road portion 116. In the illustrated embodiment, the first vehicle 106A and the second vehicle 106B are traveling in opposing directions on the road portion 116. In one embodiment, the apparatus 102 and the infotainment system 112 may be associated with the first vehicle 106A (e.g., the apparatus 102 may be an electronic control unit (ECU) integrated with the infotainment system 112, or the apparatus 102 may be a mobile device that is communicatively coupled to the infotainment system 112). In an alternative embodiment, the apparatus 102 and the infotainment system 112 may be associated with an entity (e.g., another vehicle) separate from any of the set of vehicles 106.

The apparatus 102 may include suitable logic, circuitry, interfaces, and/or code that may be configured to determine a likelihood of high-beam lights used on the road portion 116 and an impact of the high-beam lights on the behavior of users of vehicles (such as one or more vehicles among the second vehicle 106B to the Nth vehicle 106N). Specifically, the apparatus 102 may be configured to obtain sensor data and map data associated with the first vehicle 106A. In one embodiment, the sensor data may be acquired by one or more sensors of the first vehicle 106A (e.g., the current speed/heading of the first vehicle 106A). Such sensor data may indicate one or more features of the first vehicle 106A, one or more features related to the environment of the current location of the first vehicle 106A, or a combination thereof. In one embodiment, the sensor data may be acquired by one or more sensors that are not part of the first vehicle 106A. Such sensor data may indicate one or more features of the first vehicle 106A, one or more features related to the environment of the current location of the first vehicle 106A, one or more features related to the environment of a portion of a route designated for the first vehicle 106A, or a combination thereof. In one embodiment, the sensor data may be acquired from a past instance at a portion of a route designated for the first vehicle 106A. In one embodiment, the sensor data may be data acquired from a plurality of past instances at a portion of a route designated for the first vehicle 106A and combined to represent a single data value for the portion of the route. By way of example, multiple speed levels of the first vehicle 106A may be recorded at the portion of the route for multiple past instances, and the speed level of the first vehicle 106A for the portion of the route may be represented as an average of the multiple speed levels at the portion of the route. In one embodiment, the obtained map data may indicate one or more features of the current location of the first vehicle 106A. In one embodiment, the obtained map data may indicate one or more features of a portion of a route designated for the first vehicle 106A. The apparatus 102 may be configured to calculate a first probability score indicative of the usage of high-beam lights by the first vehicle 106A based on the obtained sensor data and the obtained map data. Further, the apparatus 102 may be configured to calculate a second probability score indicative of an impact on one or more behaviors of one or more users of one or more vehicles among the second vehicle 106B to the Nth vehicle 106N that is within a pre-determined distance of the first vehicle 106A based on the obtained sensor data and the obtained map data. Examples of the apparatus 102 may include, but are not limited to, an electronic control unit (ECU), an electronic control module (ECM), a computing device, a mobile device, a mainframe machine, a server, a computer workstation, and/or any other electronic device.

In one embodiment, the apparatus 102 may be onboard the first vehicle 106A and configured to determine the impact of high-beam lights on the behavior of users of other vehicles of the set of vehicles 106, such as the second vehicle 106B to the Nth vehicle 106N. In another example embodiment, the apparatus 102 may be the processing server 108A of the mapping platform 108 and therefore may be co-located with or disposed within the mapping platform 108.

In one embodiment, the apparatus 102 may be embodied as a cloud-based service, a cloud-based application, a cloud-based platform, a remote server-based service, a remote server-based application, a remote server-based platform, or a virtual computing system. In yet another example embodiment, the apparatus 102 may be an OEM (Original Equipment Manufacturer) cloud. The OEM cloud may be configured to anonymize any data received by the apparatus 102, such as the sensor data and the map data, before using the data for further processing, such as before sending the data to the set of ML models 110 (or to the map database 108B). For example, anonymization of the data may be done by the mapping platform 108.

Each vehicle of the set of vehicles 106 may be a non-autonomous vehicle, a semi-autonomous vehicle, or a fully autonomous vehicle, for example, as defined by National Highway Traffic Safety Administration (NHTSA). Examples of the set of vehicles 106 may include, but are not limited to, a two-wheeler vehicle, a three-wheeler vehicle, a four-wheeler vehicle, more than four-wheeler vehicle, a hybrid vehicle, or a vehicle with autonomous drive capability that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. The set of vehicles 106 may be a system through which an occupant (for example a rider or a user) may travel from a start point to a destination point. Examples of the two-wheeler vehicle may include, but are not limited to, an electric two-wheeler, an internal combustion engine (ICE)-based two-wheeler, or a hybrid two-wheeler. Similarly, examples of the four-wheeler vehicle may include, but are not limited to, an electric car, an internal combustion engine (ICE)-based car, a fuel-cell-based car, a solar powered-car, or a hybrid car. It may be noted here that the four-wheeler diagram of the set of vehicles 106 may be merely shown as examples in FIG. 1. The present disclosure may also be applicable to other structures, designs, or shapes of the set of vehicles 106. The description of other types of vehicles and respective structures, designs, or shapes has been omitted from the disclosure for the sake of brevity.

In some example embodiments, each vehicle of the set of vehicles 106 may include processing means such as a central processing unit (CPU), storage means such as on-board read-only memory (ROM), random access memory (RAM), and other acoustic sensors such as a microphone array, position sensors such as a global positioning system (GPS) sensor, gyroscope, a light detection and ranging (LiDAR) sensor, a proximity sensor, motion sensors such as an accelerometer, an image sensor such as a camera, a display enabled user interface such as a touch screen display, and other components as may be required for specific functionalities of the set of vehicles 106. In some example embodiments, user equipment may be associated, coupled, or otherwise integrated with the set of vehicles 106, such as an advanced driver assistance system (ADAS), a personal navigation device (PND), a portable navigation device, the infotainment system 112, and/or other devices that may be configured to provide route guidance and navigation-related functions to the user (e.g., a mobile device).

In some example embodiments, the set of vehicles 106 may generate sensor data associated with the respective vehicle of the set of vehicles 106, lane data, traffic data, and the like. In accordance with an embodiment, the sensor data may be generated by the respective vehicle of the set of vehicles 106, when one or more sensors on-board the respective vehicle may sense information relating to, for example, vehicle data, weather data, environmental data, temporal data, or a combination thereof. In accordance with an embodiment, the set of vehicles 106 may generate the sensor data in real-time and transmit it to the apparatus 102 to determine the impact of high-beam lights on the behavior of users of vehicles. In certain cases, the set of vehicles 106 may be configured to send updated sensor data periodically, for example, every five seconds, every thirty seconds, every minute, and so forth.

In an example, a user equipment may be installed in each of the set of vehicles 106 and may be configured to detect sensor data and traffic conditions on link segments and/or road segments by using image-based sensors, i.e., image sources installed in the corresponding vehicle. Alternatively, the image sources may be installed on link segments or roads, and the image sources may detect sensor data and traffic conditions for corresponding location on the link segments or roads. The image sources and/or the user equipment may transmit the detected sensor data and traffic conditions to the apparatus 102, which processes the detected data to determine the impact of high-beam lights on the behavior of users of vehicles.

The mapping platform 108 may include suitable logic, circuitry, and interfaces that may be configured to store one or more map attributes and sensor data associated with traffic on link segments and lane segments. The mapping platform 108 may be configured to store and update map data indicating the traffic data along with other map attributes, link attributes, road attributes, and traffic entities, in the map database 108B. The mapping platform 108 may include techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chip set. In other words, the mapping platform 108 may include one or more physical packages (such as chips) that include materials, components, and/or wires on a structural assembly (such as a baseboard).

In some example embodiments, the mapping platform 108 may include the processing server 108A for conducting the processing functions associated with the mapping platform 108, the map database 108B, and the sensor database 108C for storing map data and the sensor data. In one embodiment, the processing server 108A may include one or more processors configured to process requests received from the apparatus 102. The processors may fetch sensor data and/or map data from the map database 108B and the sensor data from the sensor database 108C and transmit the same to the apparatus 102 in a format suitable for use by the apparatus 102.

Continuing further, the map database 108B and the sensor database 108C may include suitable logic, circuitry, and interfaces that may be configured to store the map data and the sensor data, respectively that may be collected from an image source and/or the first vehicle 106A and/or the rest of the set of vehicles 106 traveling on a lane segment of the road portion 116, or in a region close to the lane segment. In accordance with an embodiment, such sensor data may be updated in real-time or near real-time such as within a few seconds, a few minutes, or on an hourly basis, to provide accurate and up-to-date sensor data. The sensor data may be collected from any sensor that may inform the mapping platform 108 or the map database 108B about the features within an environment that may be appropriate for traffic-related services. In accordance with an embodiment, the sensor data may be collected from any sensor that may inform the mapping platform 108, the map database 108B, or the sensor database 108C about the features within an environment that is appropriate for mapping. For example, motion sensors, inertia sensors, image capture sensors, proximity sensors, LiDAR sensors, and ultrasonic sensors may be used to collect the sensor data. The gathering of large quantities of crowd-sourced data may facilitate the accurate modeling and mapping of an environment, whether it is a road link or a link within a structure, such as in the interior of a multi-level parking structure.

The map database 108B may further be configured to store the traffic-related data and road topology and geometry-related data for a road network as map data. The map data may also include cartographic data, routing data, and maneuvering data. The map data may also include, but is not limited to, locations of intersections, diversions to be caused due to accidents, congestions or constructions, suggested roads, or links to avoid, and an estimated time of arrival (ETA) depending on different links. In accordance with an embodiment, the map database 108B may be configured to receive the map data including the road topology and geometry-related attributes related to the road network from external systems, such as one or more of background batch data services, streaming data services, and third-party service providers, via the network 114.

In accordance with an embodiment, the map data stored in the map database 108B may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the map database 108B may further store historical probe data for events (such as, but not limited to, traffic incidents, construction activities, scheduled events, and unscheduled events) associated with Point of Interest (POI) data records or other records of the map database 108B.

For example, the data stored in the map database 108B may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot, or other types of navigation. While example embodiments described herein generally relate to vehicular travel, example embodiments may be implemented for bicycle travel along bike paths, boat travel along maritime navigational routes, etc. The compilation to produce the end-user databases may be performed by a party or entity separate from the map developer. For example, a customer of the map developer, such as a navigation device developer or other end user device developer, may perform compilation on the received map database 108B in a delivery format to produce one or more compiled navigation databases.

In some embodiments, the map database 108B may be a master geographic database configured on the side of the apparatus 102. In accordance with an embodiment, the map database 108B may represent a compiled navigation database that may be used in or with end-user devices to provide navigation instructions based on the traffic data, the traffic conditions, speed adjustment, ETAs, and/or map-related functions to navigate through the intersection connected links on the route.

In some embodiments, the map data may be collected by end-user vehicles (such as the first vehicle 106A) which use vehicles on-board one or more sensors to detect data about various entities such as road objects, lane markings, links, and the like. These vehicles are also referred to as probe vehicles and form an alternate form of data source for map data collection, along with ground truth data. Additionally, data collection mechanisms like remote sensing, such as aerial or satellite photography may be used to collect the map data for the map database 108B.

For example, the map database 108B may include lane and intersection data records or other data that may represent link in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fueling stations, hotels, restaurants, museums, stadiums, offices, auto repair shops, buildings, stores, and parks. The map database 108B may additionally include data about places, such as cities, towns, or other communities, and other geographic features such as, but not limited to, bodies of water, and mountain ranges.

In some example embodiments, images received from the image source may be stored within the map database 108B of the mapping platform 108. In certain cases, the mapping platform 108, using the processing server 108A, may suitably process the received images. For example, such processing may include, suitably labeling the images based on corresponding associated lane and/or link, point of interest within the link and/or lane, and other information relating to the respective link and/or lane. Such labeled images may then be stored within the map database 108B as map data.

Each ML model of the set of ML models 110 may be trained to identify a relationship between inputs, such as a set of features in a training dataset, and output predictive values. Each ML model of the set of ML models 110 may be defined by its hyper-parameters, for example, a number of weights, cost function, input size, number of layers, and the like. The hyper-parameters of each of the set of ML models 110 may be tuned and weights may be updated to move towards a global minima of a cost function for the corresponding ML model. After several epochs of training on the feature information in the training dataset, each of the set of ML models 110 may be trained to output a prediction result for a set of inputs. The prediction result may be indicative of a usage of high-beam lights by the first vehicle 106A based on the obtained sensor data and the obtained map data and an impact on a behavior of a user of the second vehicle 106B within a pre-determined distance of the first vehicle 106A based on the obtained sensor data and the obtained map data.

Each of the set of ML models 110 may include electronic data, such as, for example, a software program, code of the software program, libraries, applications, scripts, or other logic or instructions for execution by a processing device, such as the apparatus 102. Each of the set of ML models 110 may include code and routines configured to enable a computing device, such as the apparatus 102 to perform one or more operations for calculating a first probability score indicative of a usage of high-beam lights by the first vehicle 106A based on the obtained sensor data and the obtained map data and calculating a second probability score indicative of an impact of the usage on a behavior of a user of the second vehicle 106B within a pre-determined distance of the first vehicle 106A based on the obtained sensor data and the obtained map data. Additionally, or alternatively, each of the set of ML models 110 may be implemented using hardware including a processor, a microprocessor (e.g., to perform or control the performance of one or more operations), a field-programmable gate array (FPGA), or an application-specific integrated circuit (ASIC). Alternatively, in some embodiments, each of the set of ML models 110 may be implemented using a combination of hardware and software. Examples of each of the set of ML models 110 may include, but are not limited to, a Deep Neural Network (DNN), an Artificial Neural Network (ANN), Long Short-Term Memory (LSTM) network (ANN-LSTM), a Convolutional Neural Network (CNN), a CNN-Recurrent Neural Network (RNN), a Connectionist Temporal Classification (CTC) model, or a Hidden Markov Model. In some embodiment, the apparatus 102 may include only one ML model of the set of ML models 110 to determine the impact of high-beam lights on the behavior of users of vehicles.

The infotainment system 112 may include suitable logic, circuitry, interfaces, and/or code that may be configured to render at least an audio-based data, a video-based data, or the user interface 112A in the first vehicle 106A. The infotainment system 112 may be configured to render an alert on the user interface 112A and output a navigation route on the user interface 112A. Examples of the infotainment system 112 may include, but are not limited to, an entertainment system, a navigation system, a vehicle user interface (UI) system, an Internet-enabled communication system, and other entertainment systems.

The apparatus 102 may be communicatively coupled to the set of vehicles 106 and the mapping platform 108, via the network 114. In an embodiment, the apparatus 102 may be communicatively coupled to other components not shown in FIG. 1 via the network 114. All the components in the network environment 100 may be coupled directly or indirectly to the network 114. The components described in the network environment 100 may be further broken down into more than one component and/or combined in any suitable arrangement. Further, one or more components may be rearranged, changed, added, and/or removed.

The network 114 may be wired, wireless, or any combination of wired and wireless communication networks, such as cellular, Wi-Fi, internet, local area networks, or the like. In some embodiments, the network 114 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The embodiments disclosed herein address the aforementioned problems relating to determining a likelihood of high-beam lights being used at a location at an instance/period of time and the impact of the high-beam lights on behaviors of users of vehicles proximate to the location at the instance/period of time, for example, the second vehicle 106B on the road portion 116. As mentioned above, high-beam lights which may be the brightest type of lights on the set of vehicles 106, may be angled higher than dipped lights, which allows the driver of a vehicle to see a greater expanse of the road as compared to that of low-beam lights. As such, certain situations like poor visibility due to rain, fog, etc., may require use of the high-beam lights, while in all other situations, it may be safer to use low-beam lights. The use of high-beam lights may lead to various issues for the second vehicle 106B. Firstly, the high-beam lights being extremely bright may cause glare and reduce the visibility of the driver of the second vehicle 106B. Secondly, the high-beam lights may be disorienting for the driver of the second vehicle 106B, thereby causing them to lose their bearings or become distracted, further leading to accidents or other dangerous situations on the road. Thirdly, high-beam lights may distract other drivers from the set of vehicles 106 and potentially cause the other drivers to look away from the road or to become momentarily blinded, thereby increasing the risk of a crash or accident. Fourthly, high-beam lights may cause eye strain and fatigue, especially when drivers impacted by the high-beam lights are driving for long periods of time, thereby impairing the drivers' ability to see clearly and make good decisions on the road. The driver of a vehicle (e.g. the first vehicle 106A) may not always be able to exercise the best judgment for deciding whether to use the high-beam lights or not. This may put either the driver of the first vehicle 106A or one or more of the other vehicles of the set of vehicles 106 on the road in dangerous situations. To overcome the above-mentioned problems, the aforementioned apparatus 102 is disclosed.

In operation, the apparatus 102 may be configured to obtain sensor data and map data associated with the first vehicle 106A. In some embodiments, the obtained sensor data may include vehicle data, weather data, environmental data, temporal data, or a combination thereof. Further, the obtained map data may include traffic data, link data, or a combination thereof. The obtained map data may be obtained from the map database 108B. The apparatus 102 may be further configured to calculate the first probability score indicative of the usage of high-beam lights by the first vehicle 106A based on the obtained sensor data and the obtained map data. For example, in order to calculate the first probability score, the apparatus 102 may be configured to apply the first ML model 110A on the obtained sensor data and the obtained map data, and then calculate the first probability score indicative of the usage of the high-beam lights by the first vehicle 106A based on the application of the first ML model 110A on the obtained sensor data and the obtained map data.

The apparatus 102 may be further configured to calculate a second probability score in response to the calculated first probability score satisfying a threshold. The second probability score may be indicative of an impact of the usage of the high-beam lights by the first vehicle 106A on the behavior of the user of the second vehicle 106B based on the obtained sensor data and the obtained map data. In one embodiment, to calculate the second probability score, the apparatus 102 may be configured to apply the second ML model 110B on the obtained sensor data and the obtained map data, and then calculate the second probability score based on the application of the second ML model 110B on the obtained sensor data and the obtained map data. Further, the apparatus 102 may be configured to store, in the map database 108B, association data indicative of an association between the obtained map data and the calculated second probability score in the map database 108B.

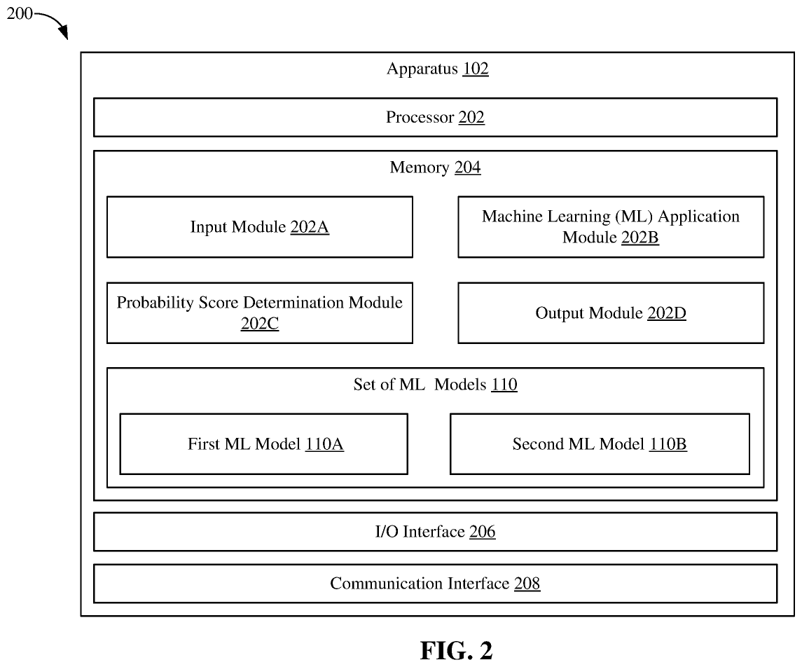

FIG. 2 illustrates a block diagram 200 of the apparatus 102 of FIG. 1, in accordance with an embodiment of the disclosure. FIG. 2 is explained in conjunction with FIG. 1. In FIG. 2, there is shown the block diagram 200 of the apparatus 102. The apparatus 102 may include at least one processor 202 (referred to as a processor 202, hereinafter), at least one non-transitory memory 204 (referred to as a memory 204, hereinafter), an input/output (I/O) interface 206, and a communication interface 208. In the illustrated embodiment, the memory 204 may include modules such as an input module 202A, a machine learning (ML) application module 202B, a probability score determination module 202C, and an output module 202D and the set of ML models 110. In one embodiment, each of said modules may be: (1) a computer-readable program code that can be executed by a processor (such as the processor 202) to perform a task designated for said module; (2) a hardware device designated to perform the designated task (in such embodiment, the hardware device is not limited to being a part of the memory 204); (3) or a combination of software and hardware components for performing the designated task (in such embodiment, the hardware component is not limited to being a part of the memory 204). The processor 202 may be connected to the memory 204, and the I/O interface 206 through wired or wireless connections. Although in FIG. 2, it is shown that the apparatus 102 includes the processor 202, the memory 204, and the I/O interface 206, the disclosure may not be so limiting, and the apparatus 102 may include fewer or more components to perform the same or other functions of the apparatus 102. Additionally, while FIG. 2 illustrates that the memory 204 includes the input module 202A, the ML application module 202B, the probability score determination module 202C, the output module 202D, and the set of ML models 110, the disclosure may not be so limiting, and the input module 202A, the ML application module 202B, the probability score determination module 202C, the output module 202D, the set of ML models 110, or a combination thereof may be embodied within the processor 202, a combination of the processor 202 and the memory 204, or a combination of other hardware/software components available within the apparatus 102. In one embodiment, the input module 202A, and the output module 202D may be integrated within the I/O interface 206. In some embodiments, the input module 202A may receive input data (such as user inputs), and the output module 202D may output processed data (such as the first probability score and the second probability score) via the I/O interface 206.

In accordance with an embodiment, the apparatus 102 may store data that may be generated by the modules while performing corresponding operations or may be retrieved from a database associated with the apparatus 102, such as the map database 108B and the sensor database 108C in the mapping platform 108. For example, the data may include vehicle data, weather data, environmental data, temporal data, traffic data, link data, or a combination thereof.

The processor 202 may execute instructions stored in the memory 204 to calculate the first probability score indicative of the usage of high-beam lights by the first vehicle 106A and the second probability score indicative of the impact of the usage on the behavior of the user of the second vehicle 106B. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the apparatus 102.

In an example, when the processor 202 is embodied as an executor of software instructions, the instructions may cause the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the communication interface 208 of the apparatus 102. The communication interface 208 may provide an interface for accessing various features and data stored in the apparatus 102.

In some embodiments, the processor 202 may be configured to provide Internet-of-Things (IoT) related capabilities to users of the apparatus 102 disclosed herein. The IoT-related capabilities may in turn be used to provide smart city solutions by providing a first probability score and a second probability score calculation, based on Big Data analysis and map-based and sensor-based data collection, by using the cloud-based mapping system for determining a likelihood of high-beam lights used by a vehicle and an impact of the high-beam lights on behavior of users of other vehicles and ensuring driver safety. The I/O interface 206 may provide an interface for accessing various features and data stored in the apparatus 102.

The input module 202A may be configured to obtain the sensor data (i.e. the vehicle data, weather data, environmental data, temporal data, etc.) and the map data (i.e. traffic data, link data, etc.). In an example, one or more sensors may be associated with the first vehicle 106A and the remaining of the set of vehicles 106, such as the one or more sensors of the first vehicle 106A, one or more sensors of the set of vehicles 106, or a combination thereof. In another example, the one or more sensors may be installed in the vicinity of link segments of the road portion 116 to obtain sensor data. For example, the one or more sensors may include one or more image sensors, one or more LIDARs, one or more speed sensors, one or more global positioning sensors (GPS), and the like.

The ML application module 202B may be configured to apply the first ML model 110A on the map data and the sensor data. The ML application module 202B may be further configured to apply the second ML model 110B on the obtained map data and the obtained sensor data along with a threshold. As mentioned above, the obtained sensor data may include vehicle data, weather data, environmental data, temporal data, or a combination thereof. The obtained map data may include traffic data, link data, or a combination thereof.

The probability score determination module 202C may be configured to calculate a first probability score. The first probability score may be indicative of the usage of high-beam lights by the first vehicle 106A based on the obtained sensor data and the obtained map data. Further, the probability score determination module 202C may be configured to calculate a second probability score indicative of the impact of the high-beam lights on the behavior of the user of the second vehicle 106B within a pre-determined distance of the first vehicle 106A based on the obtained sensor data and the obtained map data. It should be noted that the second probability score may be calculated, responsive to the calculated first probability score satisfying a threshold, i.e., when the calculated first probability score is above the threshold. As such, if the first probability score is below the threshold, the second probability score may not be calculated. However, when the first probability score is above the threshold, the second probability score may be calculated. This second probability score may indicate to the driver of the first vehicle 106A a possibility of an impact of the usage of the high-beam lights of the first vehicle 106A on one or more drivers of one or more other vehicles from the set of vehicles 106 (e.g. the second vehicle 106B to the Nth vehicle 106N). The association data indicative of the association between the obtained map data and the calculated second probability score may be stored in the map database 108B.

In one embodiment, the first probability score and the second probability score output by the probability score determination module 202C may be associated with location and temporal data. In such embodiment, the location and temporal data will indicate a location and an instance/period of time in which: (1) the first vehicle 106A is likely to use high-beam lights; and (2) the behavior of the user of the second vehicle 106B will be impacted by the usage of the high-beam lights. It is contemplated that the first probability score and the second probability score will be variable based on certain features of the obtained sensor data and the obtained map data, and the apparatus 102 must carefully choose which sensor data and the map data should be input to the first ML model 110A and the second ML model 110B to provide the most relevant information. For example, certain obtained sensor data are subject to change over time, such as speed and heading of the first vehicle 106A. Such data may be input into the first ML model 110A to determine a first probability score. In such an example, the current speed and heading of the first vehicle 106A may be the most relevant data for determining the first probability score for the current location of the vehicle 106A; however, using the current speed and the heading of the first vehicle 106A may not be relevant for determining the first probability score for a remote location (e.g., a location removed from the current location and along a route designated for the first vehicle 106A) because features of the remote location may be different than those of the current location (e.g., there may be a greater road curvature at the remote location or a different speed limit at the remote location). Thus, if a user wishes to know what the first probability score will be at the remote location, then the most relevant sensor data input to the first ML model 110A may be predicted speed and heading of a vehicle at the remote location. Thus, in such scenarios, sensor data that will be input to the first ML model 110A for determining the first probability score may be: (1) vehicle speed and heading of another vehicle at the remote location; (2) historical vehicle speed and heading of the first vehicle 106A at the remote location (i.e., past records of vehicle speed and heading of the first vehicle 106A at the remote location); or (3) combined vehicle speed and heading of vehicles at the remote location (e.g., an average vehicle speed and heading of a number of vehicles that traversed the remote location for a given period). Indeed, such dynamic data input to the first ML model 110A and/or the second ML model 110B is not limited to the speed and heading of a vehicle. For example, weather conditions may impact different locations differently. As such, continuing from the example above, if a user wishes to know what the first probability score and/or the second probability score will be at the remote location, then predicted weather conditions (which are derived from weather forecast information) of the remote location at a predicted time of which first vehicle 106A will reach the remote location will be input to the first ML model 110A and/or the second ML model 110B to derive the first probability score and/or the second probability score for the remote location.

The output module 202D may be configured to output at least one of an alert (based on the stored association data) and a first navigation route on the user interface 112A or a user interface of a mobile device.

It should be noted that the apparatus 102 may be configured to generate some additional outputs based on user inputs. For example, when a user is using a vehicle to travel from an origin location to a destination location, there may exist a plurality of possible routes between the origin location and the destination location. In such scenarios, the apparatus 102 may help the user to select a route among the plurality of possible routes, where said route is associated with the lowest first probability score (i.e. usage of high-beam lights on said route is least likely) based on association data calculated for: (1) all vehicles plying on each of the plurality of possible routes; (2) all vehicles that are designated to ply on each of the plurality of routes; (3) all vehicles that are designated to concurrently ply on each of the plurality of possible routes with the vehicle at one or more instances; or (4) a combination thereof. To this end, the apparatus 102 may receive a user input associated with a determination of a navigation route from the origin location to the destination location, and the apparatus 102 may further calculate a first probability score and a second probability score, and hence the association data for each of the plurality of possible routes. Further, the output module 202D may be further configured to output the selected route on the user interface 112A or a user interface of a mobile device.

The memory 204 of the apparatus 102 may be configured to store the sensor data, the map data, the first probability score, the second probability score, and the association data. Further, the memory 204 of the apparatus 102 may be configured to store event data and the first navigation route. The memory 204 may be further configured to store the training data. In an embodiment, the memory 204 may be configured to store the first ML model 110A and the second ML model 110B. The memory 204 may be non-transitory and may include, for example, one or more volatile and/or non-volatile memories. In other words, for example, the memory 204 may be an electronic storage device (for example, a computer readable storage medium) including gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

In some example embodiments, the I/O interface 206 may communicate with the apparatus 102 and display the input and/or output of the apparatus 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the apparatus 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry including the processor 202 may be configured to control one or more functions of one or more I/O interface 206 elements through computer program instructions (for example, software and/or firmware) stored on a memory 204 accessible to the processor 202. The processor 202 may further render notifications associated with the impact of high-beam lights on the behavior of users of vehicles, via the I/O interface 206. Additionally, the processor 202 may further render notifications associated with the navigation instructions, such as traffic data, traffic conditions, traffic congestion value, ETA, routing information, road conditions, driving instructions, etc., on the user equipment or audio or display onboard the vehicles via the I/O interface 206.

The communication interface 208 may include an input interface and an output interface for supporting communications to and from the apparatus 102 or any other component with which the apparatus 102 may communicate. The communication interface 208 may be any means such as a device or circuitry embodied in either hardware or a combination of hardware and software that may be configured to receive and/or transmit data to/from a communications device in communication with the apparatus 102. In this regard, the communication interface 208 may include, for example, an antenna (or multiple antennae) and supporting hardware and/or software for enabling communications with a wireless communication network. Additionally or alternatively, the communication interface 208 may include the circuitry for interacting with the antenna(s) to cause transmission of signals via the antenna(s) or to manage receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms. In some embodiments, the communication interface 208 may enable communication with a cloud-based network to enable deep learning, such as using the set of ML models 110 (that may be hosted on the cloud-based network).

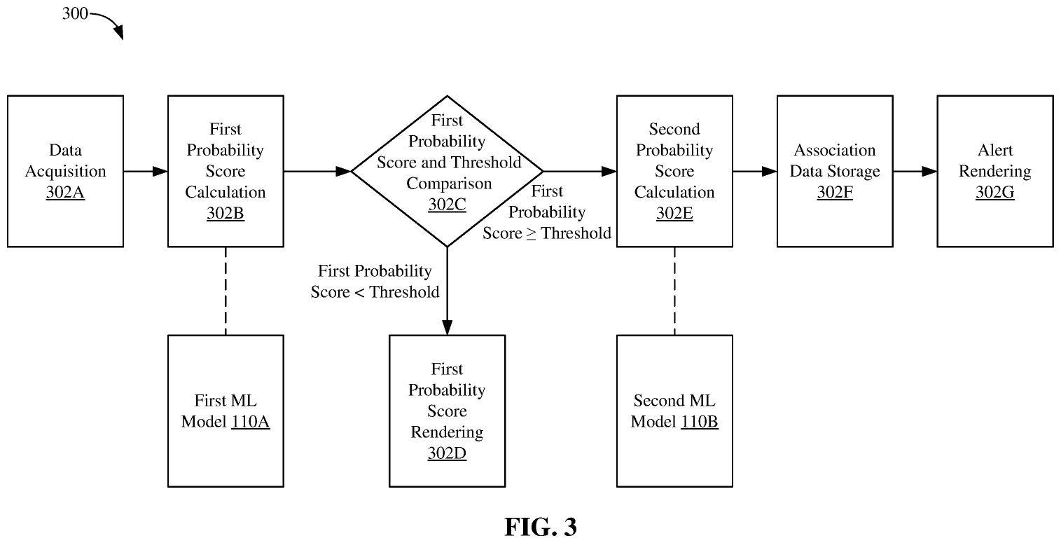

FIG. 3 is a diagram 300 that illustrates exemplary operations for determining an impact of high-beam lights on behavior of users of vehicles, in accordance with an embodiment of the disclosure. FIG. 3 is explained in conjunction with elements from FIG. 1 and FIG. 2. With reference to FIG. 3, there is shown the diagram 300 that illustrates exemplary operations from 302A to 302G, as described herein. The exemplary operations illustrated in the diagram 300 may start at 302A and may be performed by any computing system, apparatus, or device, such as by the apparatus 102 of FIG. 1 or the processor 202 of FIG. 2. Although illustrated with discrete blocks, the exemplary operations associated with one or more blocks of the diagram 300 may be divided into additional blocks, combined into fewer blocks, or eliminated, depending on the particular implementation.

In one embodiment, a user may use the apparatus 102 to determine a likelihood of one or more vehicles (e.g., the first vehicle 106A) using high-beam lights at a location and at an instance/period of time and the impact of the usage of the high-beam lights on the behavior of one or more users of one or more other vehicles (e.g., the second vehicle 106B) at the location and at the instance/period of time. The exemplary operations from 302A to 302G described herein detail said determination executed by the apparatus 102. At the outset, the exemplary operations may be executed based on a reception of a user input from the user at a mobile device or an input device available within a vehicle (e.g., the user interface 112A of the infotainment system 112).

For the exemplary operations from 302A to 302G described herein, the apparatus 102 may determine a likelihood of the first vehicle 106A using high-beam lights at a location for an instance/period of time and the impact of the usage of the high-beam lights on the behavior of a user of the second vehicle 106B at the location for the instance/period of time. However, it should be appreciated that the determination of the likelihood of high-beam lights usage and the impact thereof is not limited to the first vehicle 106A and the second vehicle 106B. Rather, said determination may be performed for any vehicles that are currently at the location for the instance/period of time or for any vehicles that are not currently at the location, but are designated to be at the location for the instance/period of time.

At 302A, a data acquisition operation may be executed. In the data acquisition operation, the apparatus 102 may be configured to obtain sensor data and map data associated with the first vehicle 106A. The map data may be obtained from the map database 108B. The sensor data may be obtained from the one or more sensors 104, the sensor database 108C, or a combination thereof. Specifically, the input module 202A may be configured to obtain the sensor data and map data associated with the first vehicle 106A.

In one embodiment, the sensor data may include vehicle data, weather data, environmental data, temporal data, or a combination thereof. In particular, the vehicle data may include data associated with vehicle speed data, data associated with heading degree difference (i.e. vehicle heading degree and link heading degree), data associated with a type of vehicle (i.e. whether it is a small car, a sedan, a small truck, a truck, a utility vehicle, etc.), and data associated with a type of transmission (i.e. automatic or manual) of the first vehicle 106A. The weather data may include data associated with weather conditions (i.e. heavy rain, fog, etc.). The environmental data may include data associated with the presence of trees or infrastructure on the edge of the road (for example, the data may be available in terms of “Yes” indicative of the presence of some tree or infrastructure or “No” indicative of an absence of tree or infrastructure). The temporal data may include day and night data, i.e. Time Of the Day (TOD) data, a start time of the event, a duration of the event, and an end time of the event.

In one embodiment, the map data may include traffic data, link data, or a combination thereof. In particular, the traffic data may include traffic conditions data, functional classes data (i.e. highway, city center, rural roads, etc.), road width data, road curvature data, road ascent or descent degree data, data associated with a presence of physical divider, and data associated with road works. The link data may be associated with attributes such as estimated roadway illumination data. The link data may be obtained from a geographic database that includes links and nodes with attributes indicating the estimated roadway illumination. The estimated roadway illumination data may be used to generate routes and operate vehicles, or in combination with other information to allow for safer and more efficient operation on the roadways.

In one embodiment, a user may use the apparatus 102 to determine a likelihood of the first vehicle 106A using high-beam lights at a location and at an instance/period of time and the impact of the usage of the high-beam lights on the behavior of the second vehicle 106B at the location and at the instance/period of time. In such embodiment, the user input provided by the user may indicate the location and the instance/period of time. In an alternative embodiment, the location and the instance/period of time may be automatically derived by the apparatus 102. For example, the user input provided by the user may indicate a route from an origin to a destination, and the location may indicate a location along the route where a vehicle of the user is estimated to be proximate (e.g., within a distance at which a driver of a vehicle can be impacted by high-beam lights) to the first vehicle 106A, and the instance/period of time may be an instance/period of time in which the vehicle of the user is estimated to be proximate to the first vehicle 106A. Accordingly, certain sensor data and map data acquired at 302A, particularly data that are variable with time and location (e.g., vehicle speed, vehicle heading, weather condition, etc.), may be estimated based on the location and the instance/period of time as indicated in the user input.

At 302B, a first probability score calculation operation may be executed. In the first probability score calculation operation, the apparatus 102 may be configured to calculate a first probability score. The first probability score may be indicative of the likelihood of the usage of high-beam lights by the first vehicle 106A at the location for the instance/period of time based on the obtained sensor data and the obtained map data at 302A. In the first probability score calculation operation, the probability score determination module 202C may be configured to calculate the first probability score indicative of the usage of high-beam lights by the first vehicle 106A based on the obtained sensor data and the obtained map data.

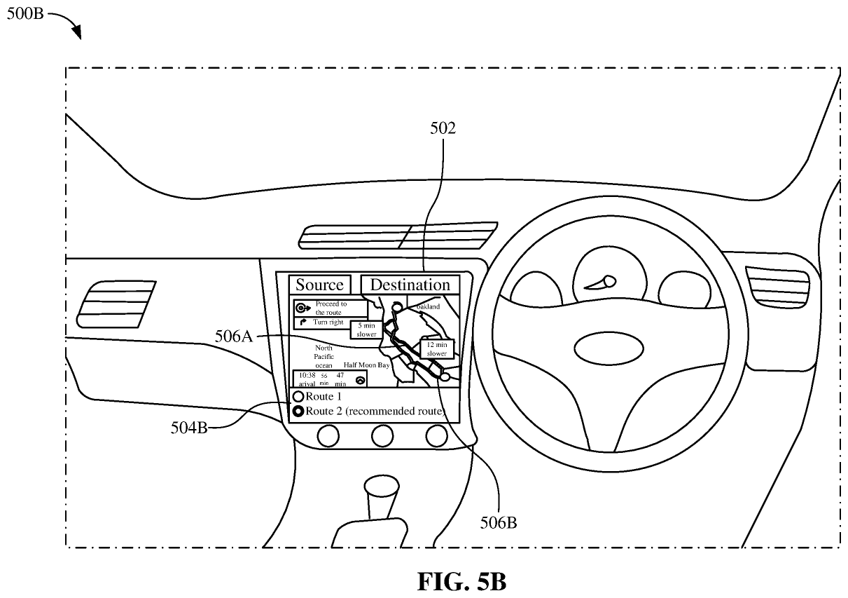

In particular, to perform the first probability score calculation operation, the probability score determination module 202C may apply the first ML model 110A model on the obtained sensor data and the obtained map data. The probability score determination module 202C may then calculate the first probability score indicative of the usage of the high-beam lights by the first vehicle based on the application of the first ML model on the obtained sensor data and the obtained map data. In one embodiment, the output of the first ML model 110A may be a probability score ranging from 0 to 1. As discussed above, the first ML model 110A may be a pre-trained ML model that may be trained on training data to output the first probability score. Details about training the first ML model 110A are provided, for example, in FIG. 6A.

At 302C, a calculated first probability score and a threshold comparison operation may be executed. In some embodiments, the threshold may be predefined. For example, the threshold may be predefined and set at 0.7. If at 302C, based on the comparison operation, it is determined that the first probability score is less than the threshold, the method 300 may proceed to 302D. Otherwise, the method 300 may proceed to 302E.

At 302D, a calculated first probability score rendering operation may be executed. It should be noted that if the first probability score is less than the threshold, the method 300 may end at 302D, and the calculated first probability may be rendered via the user interface 112A of the infotainment system 112 or a user interface of a mobile device.

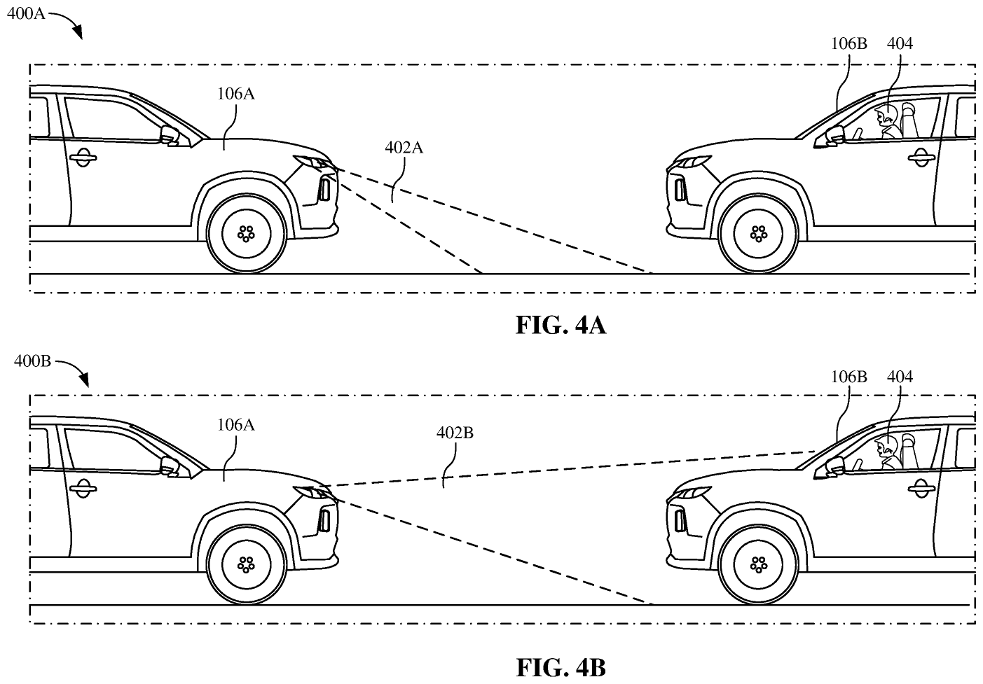

However, if at 302C (as a result of the calculated first probability score and the threshold comparison operation), it is determined that the first probability score is more than the threshold, the method 300 may proceed to 302E. As such, if the output of the first ML model 110A is equal to or above the threshold (for example, >0.7), then the same features of the first ML model may be passed on to the second ML model 110B. For the second ML model, the features may remain the same, however, the label may change. In particular, the label may have two outputs-“Yes” and “No”. Here, “Yes” may indicate a high probability of the user of the second vehicle 106B adapting the behavior thereof in response to the first vehicle's 106A usage of the high-beam lights, and “No” may indicate a low probability of the user of the second vehicle 106B adapting the behavior thereof in response to the first vehicle's 106A usage of the high-beam lights. The output of the second ML model may also be a probability score ranging from 0 to 1. If the output of the second ML model is greater than the threshold value (e.g. 0.7), then there is a high chance of the user adapting the behavior thereof in response to facing the high-beam lights of the first vehicle 106A. Details about the high-beam lights and low-beam lights are discussed in conjunction with FIG. 4A and FIG. 4B, in the subsequent sections of this disclosure.

At 302E, a second probability score calculation operation may be executed. The second probability score may be indicative of the impact of using the high-beam lights (by the first vehicle 106A) on the behavior of the user of the second vehicle 106B at the location for the instance/period of time. The second probability score may be calculated based on the obtained sensor data and the obtained map data. In the second probability score calculation operation, the probability score determination module 202C may be configured to calculate the second probability score indicative of the impact on the behavior of the user of the second vehicle 106B based on the obtained sensor data and the obtained map data. It should be noted that, although, both the second probability score calculation and the first probability score calculation are based on the obtained map data and the obtained sensor data, the second probability score calculation is performed separately from the first probability score calculation.

In particular, to perform the second probability score calculation operation, the score determination module 202C may apply the second ML model 110B on the obtained sensor data and the obtained map data. The probability score determination module 202C may then calculate the second probability score indicative of an impact on the behavior of the user of the second vehicle 106B based on the application of the second ML model 110B on the obtained sensor data and the obtained map data. The second ML model 110B may predict whether the high-beam lights cause a change in the behavior of the user of the second vehicle 106B. As discussed above, the second ML model 110B may be a pre-trained ML model that may be trained on training data to output the second probability score. Details about training the second ML model 110B are provided, for example, in FIG. 6B.

At 302F, an association data indicative of an association between the obtained map data and the calculated second probability score may be generated. Further, at 302F, the association data may be stored in the map database 108B. In other words, the association data indicative of the impact of the usage of the high-beam lights by the first vehicle 106A on the behavior of the user of the second vehicle 106B at the location for the instance/period of time may be determined, by way of calculating the second probability score. Further, in some embodiments, such association data indicative of the impact may be identified on a map, and the corresponding location on the map may be annotated with the second probability score. Further, the association data may be stored in the map database 108B which may be hosted on a centralized map database. Therefore, the association data may be made available to users of vehicles that are using the apparatus 102 to ply through the location on the map. This availability of the association data may allow the users who are plying or will be plying through the location to make informed decisions as to using high-beam lights at the location or whether to take a route including the location. For example, if a route has too many locations with a second probability score indicative of a high impact on the behavior of users of vehicles, the user may avoid taking the route and instead opt for an alternate route. For example, the association data may be stored as link level data, where each link data in the map database 108B additionally includes data in the form of labels or values that indicate an impact score of high beam headlight usage on that link.

At 302G, an alert rendering operation may be performed. As discussed above, the association data may be indicative of the impact of the usage of the high-beam lights by the first vehicle 106A on the behavior of a user of the second vehicle 106B at the location for the instance/period of time. In some embodiments, the alert may be generated to warn the user about the impact of the high-beam lights output by the first vehicle 106A on the behavior of a user of the second vehicle 106B. As such, the alert may act to discourage the user of the apparatus 102 from: (1) plying a route including the location in which the behavior of the user of the second vehicle 106B will be impacted by the high-beam lights of the first vehicle 106A; or (2) using the high-beam lights when the user traverses a route including the location.

FIG. 4A is a diagram 400A that depicts an exemplary scenario including the first vehicle 106A and the second vehicle 106B, with the first vehicle 106A having its low-beam lights switched ON, in accordance with an embodiment of the disclosure. FIG. 4B is a diagram 400B that depicts an exemplary scenario including the first vehicle 106A and the second vehicle 106B, with the first vehicle 106A having its high-beam lights switched ON, in accordance with an embodiment of the disclosure. As shown in the scenario diagrams 400A and 400B, the first vehicle 106A and the second vehicle 106B are facing each other. Further, as seen in FIG. 4A, when the low-beam lights are switched ON for the first vehicle 106A, a low-beam 402A may be directed towards the road and not towards a user 404 of the second vehicle 106B. As such, the low-beam lights may not cause a significant impact on the behavior of the user 404 of the second vehicle 106B. Therefore, low-beam lights may be used when driving near other vehicles, since the low-beam lights have a low impact on the visibility of said vehicles.

As discussed above, the high-beam lights may be the brightest type of lights on vehicles. As shown in FIG. 4B, when the high-beam lights are switched ON for the first vehicle 106A, a high-beam 402B may be angled higher than the low-beam 402A. This allows the user (i.e. driver) of the first vehicle 106A to see a greater expanse, which may be helpful in extraordinary situations, such as poor visibility due to rain, fog, etc. However, in normal situations, it may be safer to use low-beam lights. As mentioned above, the usage of high-beam lights may lead to various issues while driving including reduced visibility, disorientation, distraction, and eye strain for the user 404 of the second vehicle 106B. These issues may reduce the ability of the user 404 to see clearly and make good decisions while driving on the road. For these reasons, it also becomes important to switch between high-beam and low-beam lights with discretion, based on approaching or following other vehicles.

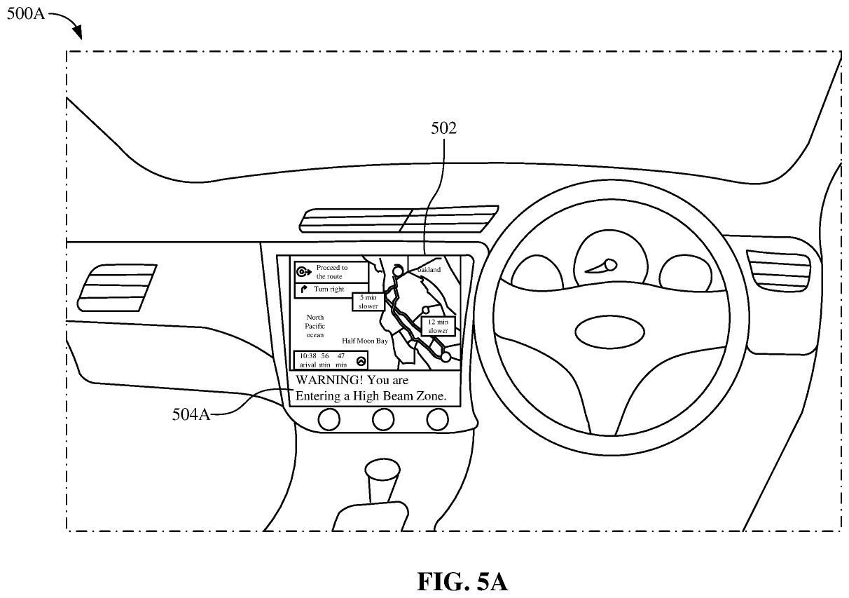

FIG. 5A and FIG. 5B are diagrams that illustrate exemplary scenarios 500A, 500B, and 500C, respectively, of additional functionalities including alert generation by the apparatus 102, in accordance with some embodiments of the disclosure. FIG. 5A and FIG. 5B are explained in conjunction with elements from FIG. 1, FIG. 2, FIG. 3, FIG. 4A, and FIG. 4B.

With reference to FIG. 5A, there is shown the exemplary scenario 500A that includes an inside view of a vehicle, showing a user interface implemented, for example, through an infotainment system 502. As mentioned above, in some embodiments, the association data indicative of the impact may be correlated with the locations on the map, and the corresponding locations may be annotated with the second probability score. Further, the association data may be stored in the map database 108B which may be hosted on a centralized map database. The association data may be used to generate an alert to warn the user of apparatus 102 and the vehicle with respect to entering a zone (location) or taking a route through locations associated with a high impact of high-beam lights on behaviors of users of vehicles. As such, as shown in FIG. 5A, an alert message 504 may be rendered on a display screen of the infotainment system 502 that may read: “You are entering a high-beam zone”. The alert message 504A may, therefore, act to warn the user to exercise extra caution while moving through the said zone or route or avoid entering the said zone or taking the said route altogether. Alternatively, when the user of the apparatus 102 is already in said zone or route, the alert may be generated to warn the user of apparatus 102 about a high impact of high-beam lights on behaviors of other vehicles in said zone or route. As such, the alert may act to discourage the user of the 106A from using the high-beam lights within said zone or route.

With reference to FIG. 5B, there is shown the exemplary scenario 500B that includes an inside view of the vehicle of FIG. 5A, showing the user interface implemented, for example, through the infotainment system 502. When the vehicle is designated to travel from an origin location to a destination location, there may exist a plurality of possible routes between the origin location and the destination location. For example, in the scenario 500B, there may exist two possible routes between the origin location and the destination location-a first route 506A, and a second route 506B. In such scenarios, the apparatus 102 may assist the user to select the best route among the two possible routes based on a probability of high-beam lights usage for each of the routes and an impact of the high-beam lights on behaviors of users of other vehicles for each of the routes. In one embodiment, the best route may be determined based on association data calculated for each of the two possible routes. The apparatus 102 may receive a user input associated with a determination of a navigation route from the origin location to the destination location and calculate the first probability score and the second probability score, and hence, the association data for each of the two possible routes. The apparatus 102 may further determine, from the map database, a first navigation route (or the best route) from the origin location to the destination location based on the stored association data. By way of example, the first navigation route (e.g. the second route 506B) may be the route selected from the two possible routes, because a comparison between association data for both the first navigation route and the second navigation route may indicate that the impact of high-beam lights on behaviors of users of vehicles in the first navigation route is less than the impact of high-beam lights on behaviors of users of vehicles in the second navigation route. Therefore, the output module 202D may be further configured to output a notification 504B on the user interface of the infotainment system 502, notifying the user about the recommended first navigation route (i.e. the second route 506B).

FIG. 6A is a diagram 600A that illustrates a process of training the first ML model 110A of the set of ML models 110 for calculating the first probability score. FIG. 6A is explained in conjunction with elements from FIGS. 1, 2, 3, 4A, 4B, 5A and 5B. With reference to FIG. 6A, there is shown the block diagram 600A of the apparatus 102 that includes the first ML model 110A. There is further shown a first training dataset 602A and the first probability score 604A.

In one embodiment, the apparatus 102 may be configured to train the first ML model 110A. The first ML model 110A may be trained on the first training dataset 602A (or training data). The first training dataset 602A may include a plurality of training samples and may correspond to a collection of examples that may be used to train the first ML model 110A to make accurate predictions or classifications. The training of the first ML model 110A may be an essential component in a machine learning process as it helps the first ML model 110A to learn patterns and relationships within input features (i.e., the set of features).

In one embodiment, the apparatus 102 may be configured to obtain training data. The obtained training data may correspond to the obtained sensor data and the obtained map data and may be indicative of features of one or more past events in which high-beam lights of vehicles were used. It should be noted that the training sensor data and the obtained sensor data may be different. Further, the training map data and the obtained map data may also be different.

In one embodiment, the apparatus 102 may be configured to train the first ML model 110A based on the obtained training data. Once trained, the first ML model 110A may be deployed in the real world to calculate the first probability score that may be indicative of the usage of high-beam lights by a vehicle, such as the first vehicle 106A. Specifically, the trained first ML model 110A may obtain sensor data and map data associated with the first vehicle 106A and a location associated with the first vehicle 106A and use the obtained sensor data and the obtained map data to output the first probability score 604A indicative of the usage of high-beam lights by the first vehicle 106A.

In one embodiment, the apparatus 102 may be configured to generate a new training sample to be included in the first training dataset 602A. In one embodiment, the new training sample may include the obtained sensor data, the obtained map data, and the determined first probability score 604A. In one embodiment, the new training sample may include ground truth data indicating whether or not high-beam lights were actually used at the location and the instance/period of time as indicated by the output of the first ML model 110A. The apparatus 102 may be further configured to re-train the first ML model 110A using the generated new training sample. Therefore, the first ML model 110A may be re-trained even when the first ML model 110A may be deployed in real-life scenarios.

In order to train the first ML model 110A, the above mapping of the events may be first translated into a vector format suitable to be used as a feature vector for the first ML model 110A. In an embodiment, the following features may translated into the vector format: traffic conditions, time of the day (i.e. day or night), functional classes (highway, city center, rural roads, etc.), road width, presence of physical divider, extreme weather conditions (e.g. heavy rain, fog, etc.), vehicle speed, heading degree difference (vehicle heading degree, link heading degree), road curvature, road ascent/descent degree, road works, presence of tree or infrastructure on the edge of the road (i.e. in terms of “Yes” or “No”), type of vehicle (i.e. small car, sedan, small truck, truck, utility, etc.), and type of transmission (i.e. automatic or manual). In short, the features related to sensor data (i.e. vehicle data, weather data, environmental data, temporal data, or a combination thereof) and the features related to the map data (i.e. traffic data, link data, or a combination thereof) may be considered. During training and using the first ML model 110A, a label may be applied. The label, for example, may indicate whether the high-beam lights have been used or not. Historic data collected for the features and the corresponding label may be considered as well.

Based on the above data, the first ML model 110A may be trained. In one embodiment, when a vehicle starts moving, current features of the vehicle (e.g., sensor data associated with the vehicle at the current location of the vehicle and map data associated with the vehicle at the current location of the vehicle) may be extracted, for example, from pre-installed map applications and sensors. In another embodiment, a route may be designated for a vehicle, and when the vehicle starts moving, current features of the vehicle, current features of a location on the route (e.g., sensor data associated with the location on the route and map data associated with the location on the route), or a combination thereof may be extracted, for example, from pre-installed map applications and sensors. The features from said embodiments may be then fed into the trained first ML model 110A. The first ML model 110A may predict whether the driver of the vehicle will use high-beam lights on a link or not. Accordingly, the first probability score 604A may be calculated. The first probability score 604A, for example, may vary between 0 to 1.

FIG. 6B is a diagram 600B that illustrates a process of training the second ML model 110B of the set of ML models 110 for determining the second probability score, in accordance with an embodiment of the disclosure. FIG. 6B is explained in conjunction with elements from FIGS. 1, 2, 3, 4A, 4B, 5A, 5B, and 6A. With reference to FIG. 6B, there is shown the block diagram 600B of the apparatus 102 that includes the second ML model 110B. There is further shown a second training dataset 602B and a second probability score 604B.

Similar to the first training dataset 602A, the second training dataset 602B may include input features and corresponding target labels. In one embodiment, the apparatus 102 may be configured to receive a training sample of a plurality of training samples included in the second training data set 602B that correspond to the obtained sensor data and the obtained map data and indicate features of one or more past events in which the high-beam lights of a set of vehicles were used and the usage of the high-beam lights impacted behaviors of users of other vehicles. In one embodiment, one or more features of the first training dataset 602A is the same as the second training dataset 602B.

In one embodiment, a training sample of a plurality of training samples included in the second training dataset 602B may include a set of features and a corresponding target label associated with the past event. Each feature of the set of features may represent a variable or an attribute that may be fed into the second ML model 110B, while the target labels may represent the desired output or prediction that the second ML model 110B may produce (i.e., the second probability score 604B).

The apparatus 102 may be configured to train the second ML model 110B using the second training dataset 602B to output the second probability score 604B that may be indicative of an impact on the behavior of a user of the second vehicle 106B based on the obtained sensor data and the obtained map data.

In one embodiment, the apparatus 102 may be configured to generate a new training sample to be included in the second training dataset 602B. In one embodiment, the new training sample may include the obtained sensor data, the obtained map data, and the determined second probability score 604B. In one embodiment, the new training sample may include ground truth data indicating whether or not high-beam lights output by a vehicle actually impacted behavior of users of other vehicles at the location and the instance/period of time as indicated by the output of the first ML model 110A. The apparatus 102 may be further configured to re-train the second ML model 110B using the generated new training sample. Therefore, the second ML model 110B may be re-trained even when the second ML model 110B may be deployed in real-life scenarios.

The second ML model 110B may predict whether the high-beam lights cause change in the driving behavior of users of other vehicles. If the output of the first ML model 110A is above a threshold value (for example, 0.7), then the same features may be passed on to the second ML model 110B. For the second ML model 110B, the features may remain the same; however, the label may change. In particular, the label may have two outputs-“Yes” and “No”. Here, “Yes” may indicate a high probability of a user of a vehicle impacted by high-beam lights adapting the behavior thereof, and “No” may indicate a low probability of the user adapting the behavior thereof. The output of the second ML model may also be a probability score ranging from 0 to 1. If the output of the second ML model is greater than the threshold value (e.g. 0.7), then there is a fair chance of the user adapting the behavior thereof in response to facing the high-beam lights.

In one embodiment, behaviors of users of vehicles impacted by high-beam lights may be defined by one or more actions performed by the users. Such actions may include, but are not limited to, flashing vehicle lights to increase the users' visibility of the road or to notify the vehicle using the high-beam lights to stop using the high-beam lights. The one or more actions may be further defined, at least in part, by instances in which the rear-view mirrors of the vehicles impacted by the high-beam lights are adjusted by the users, instances in which gazes of the users of the vehicles impacted by the high-beam lights change (e.g., a driver looks ahead of a road, then looks to the side of the road when high-beam lights are projected on to the driver), instances in which orientations of the users of the vehicles impacted by the high-beam lights change (e.g., a driver's head tilts downwards when high-beams lights are projected on to the driver), instances in which gestures of the users of the vehicles impacted by the high-beam lights correspond to certain gestures (e.g., a driver put his/her hand over his/her forehead or eyes, a driver makes a facial expression indicating discomfort or frustration), instances in which the users of the vehicles impacted by the high-beam lights maneuver the vehicles in certain manners (e.g., a driver slows his/her vehicle down, a driver steers his/her vehicle to a curb, a driver makes a U-turn), or a combination thereof.

In alternate embodiments, the set of ML models 110 may be deployed in new areas where historical information (e.g., such as data used to train the set of ML models 110) may not be available. For example, when the set of ML models 110 are used in new areas, the set of ML models 110 may be used as a baseline until data is collected for such areas. As such, the set of ML models 110 may automatically adapt to local behaviors with time. This concept may be referred to as transfer learning. As will be further appreciated, in transfer learning, knowledge acquired from a task may be re-used to boost performance on a related task. For example, for image classification, knowledge gained while learning to recognize cars may be applied when trying to recognize trucks. Reusing/transferring information from previously learned tasks to new tasks may improve learning efficiency.

In one embodiment, the set of ML models 110 may make use of mobility graphs (i.e. historical mobility patterns). In other words, the set of ML models 110 may leverage historical information from a given user or set of users (e.g. drivers) who may tend to accomplish the same actions (i.e. turning ON or OFF high-beam lights) at the same locations, for example, due to habits. The set of ML models 110 may further capture contexts leading to the frequent switches between low-beam and high-beam lights. The information about repeated patterns may be used to learn and make more accurate predictions.

It may be noted that the first training dataset 602A and the second training dataset 602B may be carefully selected and be representative of a real-world events in which high-beam lights of vehicles are used and said high-beam lights impacted behaviors of users of other vehicles. The first training dataset 602A and the second training dataset 602B may cover various scenarios and may adequately capture the variability and complexity for predicting said events based on the obtained sensor data and the obtained map data. In addition, it may be important to have a sufficient amount of diverse and well-labeled data in the first training dataset 602A and the second training dataset 602B to train the first ML model 110A and the second ML model 110B effectively.

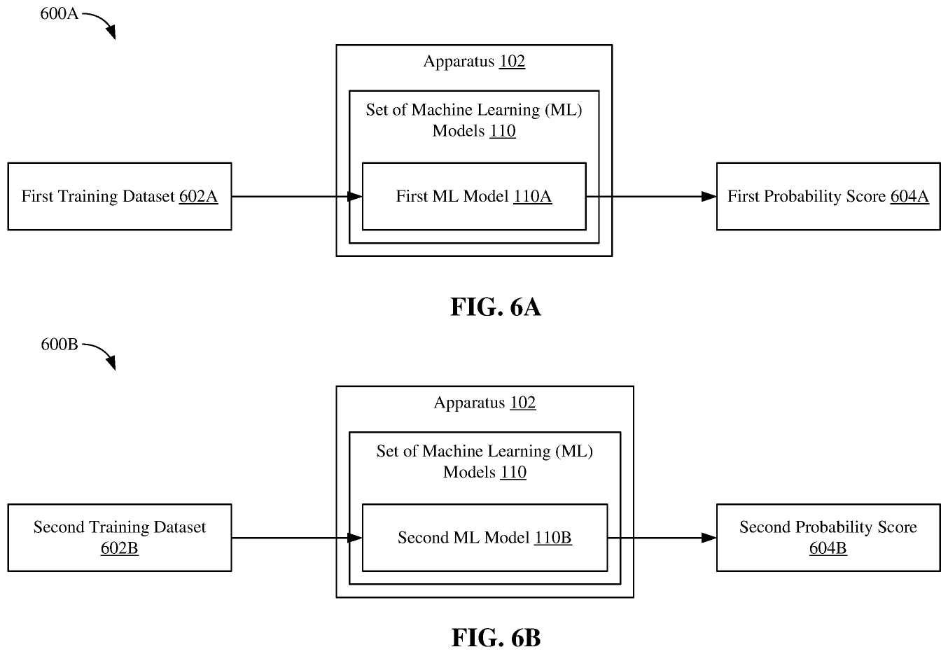

FIG. 7 is a flowchart 700 that illustrates an exemplary method of determining an impact of high-beam lights on behavior of users of vehicles, in accordance with an embodiment of the disclosure. FIG. 7 is explained in conjunction with elements from FIGS. 1, 2, 3, 4A, 4B, 5A, 5B, 6A, and 6B. With reference to FIG. 7, there is shown a flowchart 700. The operations of the exemplary method may be executed by any computing system, for example, by the apparatus 102 of FIG. 1 or the processor 202 of FIG. 2. The operations of the flowchart 700 may start at 702.

At 702, sensor data and map data associated with the first vehicle 106A may be obtained. In one embodiment, the obtained map data may be obtained from a map database 108B, and the obtained sensor data may be obtained from a sensor database 108C. In one embodiment, the obtained sensor data may be obtained directly from the one or more sensors 104. In one embodiment, the sensor data obtained from the one or more sensors 104 may be stored in the sensor database 108C, and then may be fetched from the sensor database 108C. By way of example, the obtained sensor data may include: (1) vehicle data (e.g. data associated with vehicle speed data, data associated with heading degree difference (i.e. vehicle heading degree and link heading degree), data associated with a type of vehicle (i.e. whether the vehicle is a small car, a sedan, a small truck, a truck, a utility vehicle, etc.), and data associated with a type of transmission (i.e. automatic or manual) of the vehicle); (2) weather data (e.g. data associated with extreme weather conditions (i.e. heavy rain, fog, etc.)); (3) environmental data (e.g. data associated with the presence of tree or infrastructure on the edge of the road, presence of a physical divider, etc.); (4) temporal data (e.g. include day and night data, i.e. the Time Of the Day (TOD) data); or (5) a combination thereof. The obtained map data may include: (1) traffic data (e.g. traffic conditions data, functional classes data (i.e. highway, city center, rural roads, etc.), road width data, road curvature data, road ascent or descent degree data, and data associated with road works); (2) link data (e.g. data associated with attributes such as estimated roadway illumination data); or (3) a combination thereof.

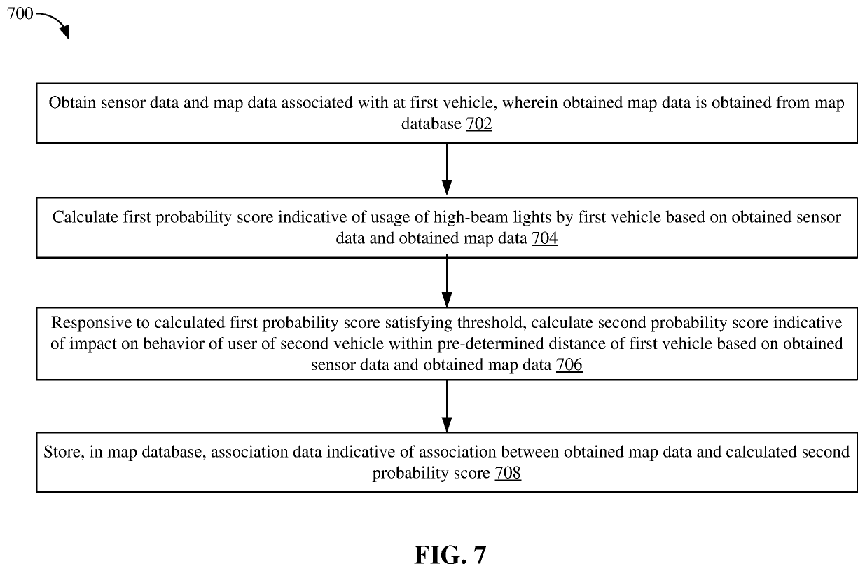

At 704, a first probability score may be calculated. The first probability score may be indicative of the usage of high-beam lights by the first vehicle based on the obtained sensor data and the obtained map data. The first probability score calculation is further explained in conjunction with FIG. 8.

FIG. 8 is a flowchart 800 that illustrates an exemplary method of calculating the first probability score, in accordance with an embodiment of the disclosure. FIG. 8 is explained in conjunction with elements from FIGS. 1, 2, 3, 4A, 4B, 5A, 5B, 6A, 6B, and 7. The flowchart 800 of FIG. 8 is an extension of the flowchart 700. The operations of the exemplary method of the flowchart 800 may be executed by any computing system, for example, by the apparatus 102 of FIG. 1 or the processor 202 of FIG. 2. The operations of the flowchart 800 may start at 802.

At 802, the trained first ML model 110A may be applied on the obtained sensor data and the obtained map data. In one embodiment, the apparatus 102 may be configured to calculate the first probability score. Details about the first probability score are provided, for example, in FIG. 3.

At 804, the first probability score indicative of the usage of the high-beam lights by the first vehicle 106A may be calculated based on the application of the trained first ML model 110A on the obtained sensor data and the obtained map data.

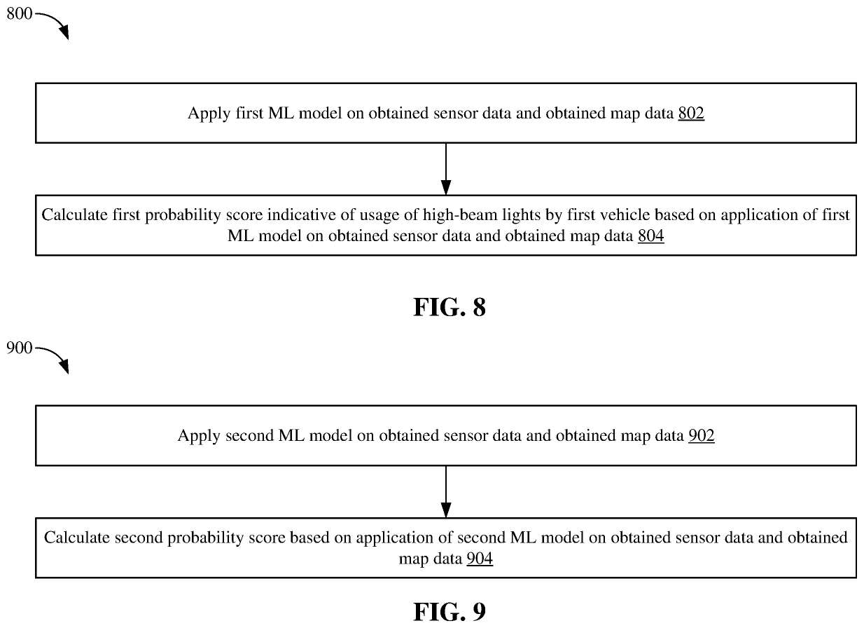

Referring back to FIG. 7, at 706, responsive to the calculated first probability score satisfying a threshold (e.g., 0.7), a second probability score may be calculated. In other words, the method 700 proceeds to 706 when the calculated first probability score indicates that the first vehicle 106A is likely to use high-beam lights at a location and at an instance/period of time. The second probability score may be indicative of an impact of the high-beam lights on the behavior of the user 404 of the second vehicle 106B. The calculation of the second probability score is further explained in conjunction with FIG. 9.

FIG. 9 is a flowchart 900 that illustrates an exemplary method of calculating the second probability score, in accordance with an embodiment of the disclosure. FIG. 9 is explained in conjunction with elements from FIGS. 1, 2, 3, 4A, 4B, 5A, 5B, 6A, 6B, 7, and 8. The flowchart 900 may be an extension of the flowchart 700. The operations of the exemplary method of the flowchart 900 may be executed by any computing system, for example, by the apparatus 102 of FIG. 1 or the processor 202 of FIG. 2. The operations of the flowchart 900 may start at 902.

At 902, the trained second ML model 110B may be applied on the obtained sensor data and the obtained map data. As discussed above, the first ML model 110A may be trained to calculate the second probability score. Details about the second probability score are provided, for example, in FIG. 3.

At 904, the second probability score may be calculated based on the application of the trained second ML model on the obtained sensor data and the obtained map data. In one embodiment, the apparatus 102 may be configured to calculate the second probability score.

Referring back to FIG. 7, at 708, association data indicative of an association between the obtained map data and the calculated second probability score may be obtained and stored in the map database 108B.

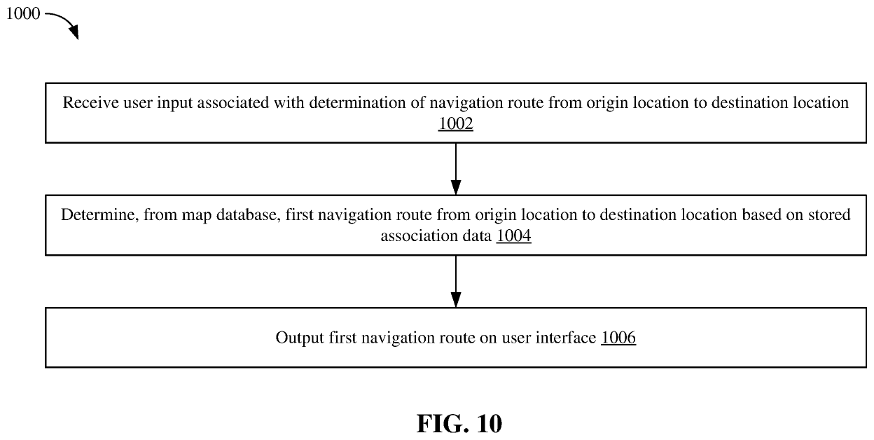

FIG. 10 is a flowchart 1000 that illustrates an exemplary method of determining a first navigation route on a user interface, in accordance with an embodiment of the disclosure. FIG. 10 is explained in conjunction with elements from FIGS. 1, 2, 3, 4A, 4B, 5A, 5B, 6A, 6B, 7, 8, and 9. The operations of the exemplary method of the flowchart 1000 may be executed by any computing system, for example, by the apparatus 102 of FIG. 1 or the processor 202 of FIG. 2. The operations of the flowchart 1000 may start at 1002. Some such outputs based on the association data are already explained in conjunction with FIG. 5B.

At 1002, a user input associated with a determination of a navigation route from an origin location to a destination location may be received from a user. For example, when the first vehicle 106A is traveling from an origin location to a destination location, there may exist a plurality of possible routes between the origin location and the destination location. In such scenarios, the apparatus 102 may help the user to select the best route among the plurality of possible routes that has the least amount of high-beam lights usage. To this end, the apparatus 102 may receive a user input associated with a determination of a navigation route from the origin location to the destination location. The apparatus 102 may further calculate the first probability score and the second probability score, and hence the association data for each of the plurality of possible routes.

At 1004, a first navigation route from the origin location to the destination location may be determined, from the map database 108B, based on the stored association data. By way of example, the first navigation route may be a route selected from the plurality of possible routes, for which the association data of that route indicates the lowest impact on behaviors of users impacted by high-beam lights.

At 1006, the first navigation route may be outputted on the user interface 112A. In particular, the output module 202D may output the first navigation route on the user interface 112A.

Accordingly, blocks of the flowcharts 700, 800, 900, and 1000 support combinations of means for performing the specified functions and combinations of operations for performing the specified functions. It will also be understood that one or more blocks of the flowcharts 700, 800, 900, and 1000, and combinations of blocks in the flowcharts 700, 800, 900, and 1000, may be implemented by special-purpose hardware-based computer systems which perform the specified functions, or combinations of special-purpose hardware and computer instructions.

Alternatively, the apparatus 102 may include means for performing each of the operations described above. In this regard, according to an example embodiment, examples of means for performing operations may include, for example, the processor 202 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one non-transitory memory including computer program code instructions, the computer program code instructions configured to, when executed, cause the apparatus to:
obtain sensor data and map data associated with at a first vehicle, wherein the obtained map data is obtained from a map database;
calculate a first probability score indicative of a usage of high-beam lights by the first vehicle based on the obtained sensor data and the obtained map data;
responsive to the calculated first probability score satisfying a threshold, calculate a second probability score indicative of an impact on a behavior of a user of a second vehicle within a pre-determined distance of the first vehicle based on the obtained sensor data and the obtained map data; and
store, in the map database, association data indicative of an association between the obtained map data and the calculated second probability score.

2. The apparatus of claim 1, wherein the obtained sensor data comprises vehicle data, weather data, environmental data, temporal data, or a combination thereof, and wherein the obtained map data comprises traffic data, link data, or a combination thereof.

3. The apparatus of claim 1, wherein, to calculate the first probability score, the computer program code instructions are configured to, when executed, cause the apparatus to:
apply a first machine learning (ML) model on the obtained sensor data and the obtained map data; and
calculate the first probability score indicative of the usage of the high-beam lights by the first vehicle based on the application of the first ML model on the obtained sensor data and the obtained map data.

4. The apparatus of claim 1, wherein, to calculate the second probability score, the computer program code instructions are configured to, when executed, cause the apparatus to:
apply a second ML model on the obtained sensor data and the obtained map data; and
calculate the second probability score based on the application of the second ML model on the obtained sensor data and the obtained map data.

5. The apparatus of claim 1, wherein the computer program code instructions are configured to, when executed, cause the apparatus to:
obtain training data, wherein the obtained training data corresponds to the obtained sensor data and the obtained map data and indicating features of one or more events in which the high-beam lights of a set of vehicles were used and the usage of the high-beam lights impacted other vehicles; and
train a first machine learning (ML) model and a second ML model based on the training data,
wherein, to calculate the first probability score, the computer program code instructions are configured to, when executed, cause the apparatus to:
apply the trained first ML model on the obtained sensor data and the obtained map data; and
calculate the first probability score indicative of the usage of the high-beam lights by the first vehicle based on the application of the trained first ML model on the obtained sensor data and the obtained map data, and
wherein, to calculate the second probability score, the computer program code instructions are configured to, when executed, cause the apparatus to:
apply the trained second ML model on the obtained sensor data and the obtained map data; and
calculate the second probability score based on the application of the trained second ML model on the obtained sensor data and the obtained map data.

6. The apparatus of claim 5, wherein the training data include training sensor data acquired by the set of vehicles during the one or more events and training map data indicating features of the one or more events, and wherein the training sensor data and the obtained sensor data are different, and wherein the training map data and the obtained map data are different.

7. The apparatus of claim 5, wherein the one or more events are defined, at least in part, by instances in which: (i) vehicle speeds of the other vehicles changed during the one or more events; (ii) trajectories of the other vehicles changed during the one or more events; (iii) lights of the other vehicles flashed during the one or more events; (iv) mirrors of the other vehicles were adjusted during the one or more events; (v) gazes of drivers of the other vehicles changed during the one or more events; (vi) orientations of the drivers of the other vehicles changed during the one or more events; (vii) facial expressions of the drivers of the other vehicles changed during the one or more events; or (viii) a combination thereof.

8. The apparatus of claim 1, wherein the computer program code instructions are configured to, when executed, cause the apparatus to render, based on the stored association data, an alert on a user interface.

9. The apparatus of claim 1, wherein the computer program code instructions are configured to, when executed, cause the apparatus to:
receive a user input associated with a determination of a navigation route from an origin location to a destination location;
determine, from the map database, a first navigation route from the origin location to the destination location based on the stored association data; and
output the first navigation route on a user interface.

10. A method comprising:
obtaining sensor data and map data associated with at a first vehicle, wherein the obtained map data is obtained from a map database;
calculating a first probability score indicative of a usage of high-beam lights by the first vehicle based on the obtained sensor data and the obtained map data;
responsive to the calculated first probability score satisfying a threshold, calculate a second probability score indicative of an impact on a behavior of a user of a second vehicle within a pre-determined distance of the first vehicle based on the obtained sensor data and the obtained map data; and
storing, in the map database, association data indicative of an association between the obtained map data and the calculated second probability score.

11. The method of claim 10, wherein the obtained sensor data comprises vehicle data, weather data, environmental data, temporal data, or a combination thereof, and wherein the obtained map data comprises traffic data, link data, or a combination thereof.

12. The method of claim 10, wherein the calculating the first probability score comprises:
applying a first machine learning (ML) model on the obtained sensor data and the obtained map data; and
calculating the first probability score indicative of the usage of the high-beam lights by the first vehicle based on the application of the first ML model on the obtained sensor data and the obtained map data.

13. The method of claim 10, wherein the calculating the second probability score comprises:
applying a second ML model on the obtained sensor data and the obtained map data; and
calculating the second probability score based on the application of the second ML model on the obtained sensor data and the obtained map data.

14. The method of claim 10, the method further comprising:
obtaining training data, wherein the obtained training data corresponds to the obtained sensor data and the obtained map data and indicating features of one or more events in which the high-beam lights of a set of vehicles were used and the usage of the high-beam lights impacted other vehicles; and
training a first machine learning (ML) model and a second ML model based on the training data,
wherein the calculating the first probability score comprises:
applying the trained first ML model on the obtained sensor data and the obtained map data; and
calculating the first probability score indicative of the usage of the high-beam lights by the first vehicle based on the application of the trained first ML model on the obtained sensor data and the obtained map data, and
wherein the calculating the second probability score comprises:
applying the trained second ML model on the obtained sensor data and the obtained map data; and
calculating the second probability score based on the application of the trained second ML model on the obtained sensor data and the obtained map data.

15. The method of claim 14, wherein the training data include training sensor data acquired by the set of vehicles during the one or more events and training map data indicating features of the one or more events, and wherein the training sensor data and the obtained sensor data are different, and wherein the training map data and the obtained map data are different.

16. The method of claim 14, wherein the one or more events are defined, at least in part, by instances in which: (i) vehicle speeds of the other vehicles changed during the one or more events; (ii) trajectories of the other vehicles changed during the one or more events; (iii) lights of the other vehicles flashed during the one or more events; (iv) mirrors of the other vehicles were adjusted during the one or more events; (v) gazes of drivers of the other vehicles changed during the one or more events; (vi) orientations of the drivers of the other vehicles changed during the one or more events; (vii) facial expressions of the drivers of the other vehicles changed during the one or more events; or (viii) a combination thereof.

17. The method of claim 10, further comprising rendering, based on the stored association data, an alert on a user interface.

18. The method of claim 10, further comprising:
receiving a user input associated with a determination of a navigation route from an origin location to a destination location;
determining, from the map database, a first navigation route from the origin location to the destination location based on the stored association data; and
outputting the first navigation route on a user interface.

19. A non-transitory computer-readable storage medium having computer program code instructions stored therein, the computer program code instructions, when executed by at least one processor, cause the at least one processor to:
obtain sensor data and map data associated with at a first vehicle, wherein the obtained map data is obtained from a map database;
calculate a first probability score indicative of a usage of high-beam lights by the first vehicle based on the obtained sensor data and the obtained map data;
responsive to the calculated first probability score satisfying a threshold, calculate a second probability score indicative of an impact on a behavior of a user of a second vehicle within a pre-determined distance of the first vehicle based on the obtained sensor data and the obtained map data; and
store, in the map database, association data indicative of an association between the obtained map data and the calculated second probability score.

20. The non-transitory computer-readable storage medium of claim 19, wherein the obtained sensor data comprises vehicle data, weather data, environmental data, temporal data, or a combination thereof, and wherein the obtained map data comprises traffic data, link data, or a combination thereof.
